(19) United States
(12) Patent Application Publication
(10) Pub. No.: US 2006/0007486 A1
(43) Pub. Date: Jan. 12, 2006

(54) Image communication device

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/175,475

(22) Filed: Jul. 7, 2005

(30) Foreign Application Priority Data
Jul. 8, 2004 (JP) 2004-201462
Jul. 8, 2004 (JP) 2004-201479
Jul. 8, 2004 (JP) 2004-201489
Jul. 8, 2004 (JP) 2004-201498

(51) Int. Cl. G06F 15/00

(52) U.S. Cl. 358/1.15

(57) ABSTRACT

An image communication device which can transmit text data designated arbitrarily by a user while transmitting image data to a destination. The image data is transmitted in a media session established by a Session Initiation Protocol (SIP) and the designated text data and a command are transmitted by a SIP method. A recipient receives the image data and outputs the text data, executes a command processing and reads out the text data by voice.

### BACKGROUND OF THE INVENTION

1. Field of the Invention

The present invention relates to an image communication device such as a facsimile machine which transmits and receives image data and text data by using a call control protocol such as the Session Initiation Protocol (SIP).

2. Description of Related Art

Recently, communication devices, which carry out various data communications through an Internet Protocol (IP) network such as an IP telephone communication and an electronic mail communication, are becoming widespread. A proposal is made on a facsimile machine, which carries out a data communication for both voice data and image data. For example, according to a conventional technology, a facsimile machine includes an IP telephone communication function and an IP facsimile communication function based on the International Telecommunication Union-Telecommunications (ITU-T) recommendation T.38 and is capable of carrying out transmission and reception by an IP telephone communication and an IP facsimile communication at the same time.

The conventional facsimile machine can carry out a voice communication with a destination while transmitting and receiving image data to and from the destination. However, the conventional facsimile machine cannot exchange character information, which is designated arbitrarily by a user, in real-time with the destination while transmitting and receiving the image data. Thus, the conventional facsimile machine is inconvenient when informing the destination as to information such as a Chinese character and an electronic mail address, which is difficult to be explained in the voice communication.

According to the conventional facsimile machine using a call control protocol, a processing to be executed on image data of a transmission original document, such as printing, forwarding and saving, is determined by a setting or the like of a recipient facsimile machine. A transmitter of the image data of the original document cannot instruct the recipient facsimile machine as to the processing to be executed on the image data. Therefore, in order for a user of the transmitter to instruct the recipient to execute a desired processing on the image data of the transmission original document, the user of the transmitter is required to make contact with the user of the recipient facsimile machine by a telephone or the like and request for a change in the setting. Thus, the conventional facsimile machine is inconvenient.

According to the conventional facsimile machine, the data communication can be carried out at the same time for both the image data and the voice data. Therefore, while transmitting the image data of the original document to the destination, the transmitter of the original document can inform the recipient as to a comment or the like regarding the original document by a voice communication. However, to do that, the transmitter is required to make a telephone call and ask the recipient to come to a telephone (a handset of the facsimile machine). If the recipient is busy at all times and a content of the comment to be informed is a small matter, there are cases in which the transmitter has to refrain from making the comment. In case of a simple comment, the comment can be written on paper and transmitted as image data along with the original document. However, in such a case, an extra sheet is wasted at both the transmitter and the recipient, respectively.

### SUMMARY OF THE INVENTION

The present invention has been made in consideration of the above-described circumstances. An advantage of the present invention is to provide an image communication device which can transmit and receive character information, which is designated arbitrarily by a user, in real-time to and from a destination while transmitting and receiving image data to and from the same destination.

Another advantage of the present invention is to provide an image communication device which transmits and receives image data of an original document by using a call control protocol, and in particular, a facsimile machine which can instruct a recipient image communication device as to a processing of image data of an original document transmitted by a transmitter.

Another advantage of the present invention is to provide an image communication device which transmits and receives image data of an original document by using a call control protocol, and in particular, an image communication device which can transmit the image data of the original document and inform a message by voice without calling a user of a recipient to a handset.

According to an aspect of the present invention, the image communication device includes an image data transmitting unit, a text data designating unit and a text data transmitting unit. The image data transmitting unit transmits image data in a media session established by a call control protocol. The text data designating unit designates text data to be transmitted. The text data transmitting unit transmits the designated text data by a method of the call control protocol.

According to another aspect of the present invention, the image communication device includes an image data transmitting and receiving unit and an output unit. The image data transmitting unit transmits and receives image data in a media session established by a call control protocol. The output unit outputs the text data received by a method of the call control protocol.

According to another aspect of the present invention, the image communication device includes an image data transmitting and receiving unit, a text data designating unit and a text data replying unit. The image data transmitting and receiving unit transmits and receives image data in a media session established by a call control protocol. The text data designating unit designates text data to be replied to a transmitter of the text data received by a method of the call control protocol. The text data replying unit replies the designated text data to the transmitter.

According to another aspect of the present invention, the image communication device includes an image data transmitting unit, a command designating unit and a command transmitting unit. The image data transmitting unit transmits image data in a media session established by a call control protocol. The command designating unit designates a text format command indicating a processing to be executed on the image data to be transmitted. The command transmitting unit transmits the designated command by a method of the call control protocol.

According to another aspect of the present invention, the image communication device includes an image data receiving unit, a text data receiving unit, a command storage unit and an execution unit. The image data receiving unit receives image data in a media session established by a call control protocol. The text data receiving unit receives text data by a method of the call control protocol. The command storage unit stores a text format command and a processing to be executed by associating with one another. In case the text data received by the text data receiving unit corresponds with the command stored in the command storage unit, the executing unit executes a processing associated with the command on the image data received by the image data receiving unit.

According to another aspect of the present invention, the image communication device includes an image data receiving unit, a text data receiving unit and a forwarding unit. The image data receiving unit receives image data in a media session established by a call control protocol. The text data receiving unit receives text data by a method of the call control protocol. In case a forwarding instruction command indicating to forward the image data is included in the text data received by the text data receiving unit, the forwarding unit forwards text data described in a prescribed area of the received text data to a prescribed destination.

According to another aspect of the present invention, the image communication device includes an image data receiving unit, a text data receiving unit and a voice output unit. The image data receiving unit receives image data in a media session established by a call control protocol. The text data receiving unit receives the text data by a method of the call control protocol. The voice output unit converts the received text data into voice data and outputs by voice.

According to another aspect of the present invention, the image communication device includes an image data receiving unit, a text data receiving unit, a voice data storage unit and a voice output unit. The image data receiving unit receives image data in a media session established by a call control protocol. The text data receiving unit receives text data by a method of the call control protocol. The voice data storage unit stores a plurality of voice data. The voice output unit selects either one of the plurality of the voice data stored in the voice data storage unit in accordance with a type of the received data and outputs the selected voice data by voice.

### BRIEF DESCRIPTION OF THE SEVERAL VIEWS OF THE DRAWINGS

FIG. 1 shows an example of a configuration of a facsimile machine according to a first embodiment of the present invention.

FIG. 2 shows an example of a table which registers a destination IP telephone number (destination information) and text data by associating with one another.

FIG. 3 shows an example of a table which registers a document type and text data by associating with one another.

FIG. 4 is a sequence diagram showing an outline of a communication procedure formed by facsimile machines when executing an IP facsimile communication according to the first embodiment of the present invention.

FIG. 5 is a flowchart showing a processing operation executed by a facsimile machine when carrying out an IP facsimile transmission or a G3 facsimile transmission according to the first embodiment of the present invention.

FIG. 6 is a flowchart showing a processing operation of a caller facsimile machine executed when a designation of text data is carried out.

FIG. 7 shows a specific example of display screens displayed at the caller facsimile machine when the designation of the text data is carried out.

FIG. 8 is a flowchart showing a processing operation executed by a facsimile machine when receiving text data according to a second embodiment of the present invention.

FIG. 9 is a flowchart showing a processing operation of the facsimile machine executed when a designation of text data is carried out according to the second embodiment of the present invention.

FIG. 10 is a sequence diagram showing an outline of an example of a communication procedure formed by facsimile machines when executing an IP facsimile communication according to the second embodiment of the present invention.

FIG. 11 shows a specific example of display screens displayed at a facsimile machine when the designation of the text data is carried out.

FIG. 12 is a flowchart showing a processing operation of a called facsimile machine executed when receiving an IP facsimile according to the second embodiment of the present invention.

FIG. 13 is a sequence diagram showing an outline of an example of a communication procedure formed by facsimile machines when executing an IP facsimile communication according to the second embodiment of the present invention.

FIG. 14 is a sequence diagram showing an outline of an example of a communication procedure formed by facsimile machines when executing an IP facsimile communication according to a third embodiment of the present invention.

FIG. 15 is a flowchart showing a processing operation executed by a caller facsimile machine when carrying out an IP facsimile transmission or a G3 facsimile transmission according to the third embodiment of the present invention.

FIG. 16 is a flowchart showing a processing operation of a caller facsimile machine executed when a designation of a command is carried out at the caller facsimile machine according to the third embodiment of the present invention.

FIG. 17 shows a specific example of display screens displayed at the caller facsimile machine when the designation of the command is carried out.

FIG. 18 is a flowchart showing a processing operation of a called facsimile machine executed when receiving an IP facsimile according to the third embodiment of the present invention.

FIG. 19 is a sequence diagram showing an outline of an example of a communication procedure formed by facsimile machines when executing an IP facsimile communication according to a fourth embodiment of the present invention.

FIG. 20 is a flowchart showing a processing operation executed by a caller facsimile machine when carrying out an IP facsimile transmission or a G3 facsimile transmission according to the fourth embodiment of the present invention.

FIG. 21 shows a specific example of display screens displayed at a caller facsimile machine when a designation of a message and forwarding destination information is carried out according to the fourth embodiment of the present invention.

FIG. 22 is a flowchart showing a processing operation of the caller facsimile machine executed when the designation of the message and the forwarding destination information is carried out according to the fourth embodiment of the present invention.

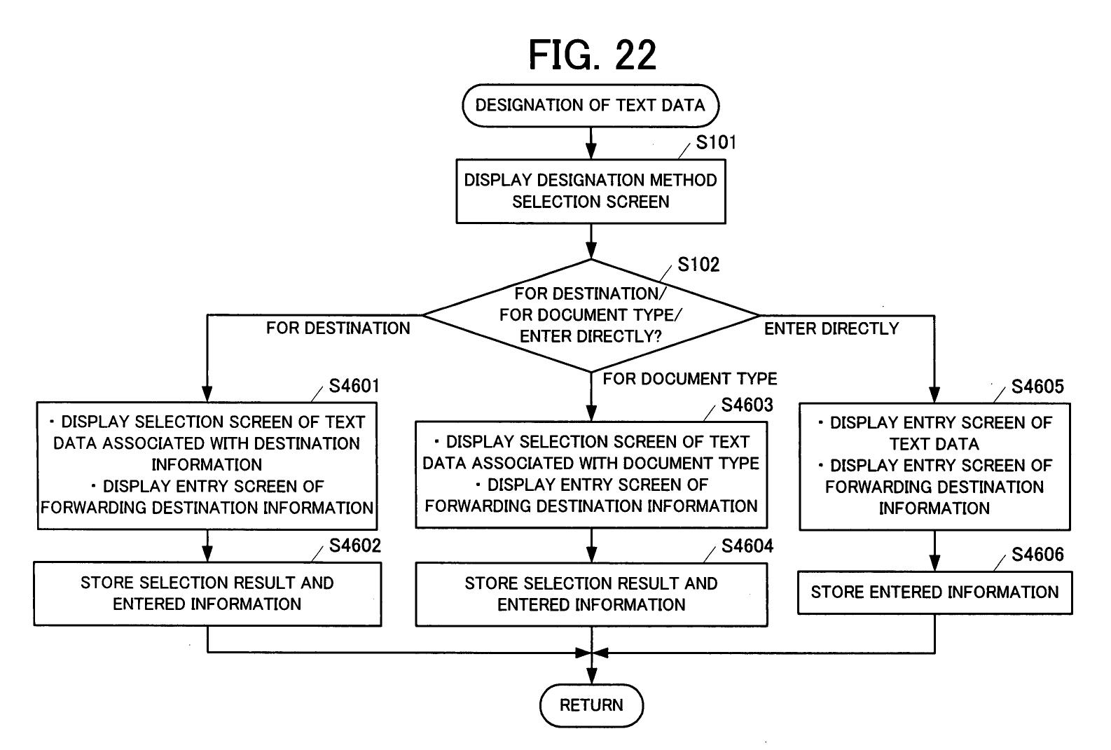

FIG. 23 is a flowchart showing a processing operation of a called facsimile machine executed when receiving an IP facsimile according to the fourth embodiment of the present invention.

FIG. 24 shows an example of a configuration of a facsimile machine according to a fifth embodiment of the present invention.

FIG. 25 is a sequence diagram showing an outline of an example of a communication procedure formed by facsimile machines when executing an IP facsimile communication according to the fifth embodiment of the present invention.

FIG. 26 is a flowchart showing a processing operation executed by a called facsimile machine when receiving various data according to the fifth embodiment of the present invention.

### DETAILED DESCRIPTION OF THE INVENTION

### First Embodiment

As an image communication device according to an embodiment of the present invention, a description will be made of an example of a Multi Function Peripheral (MFP) facsimile machine having an IP facsimile communication function for transmitting image data of an original document by using a call control protocol and a G3 facsimile communication function, and a facsimile server function for carrying out various facsimile communications according to a request from a client device, or the like.

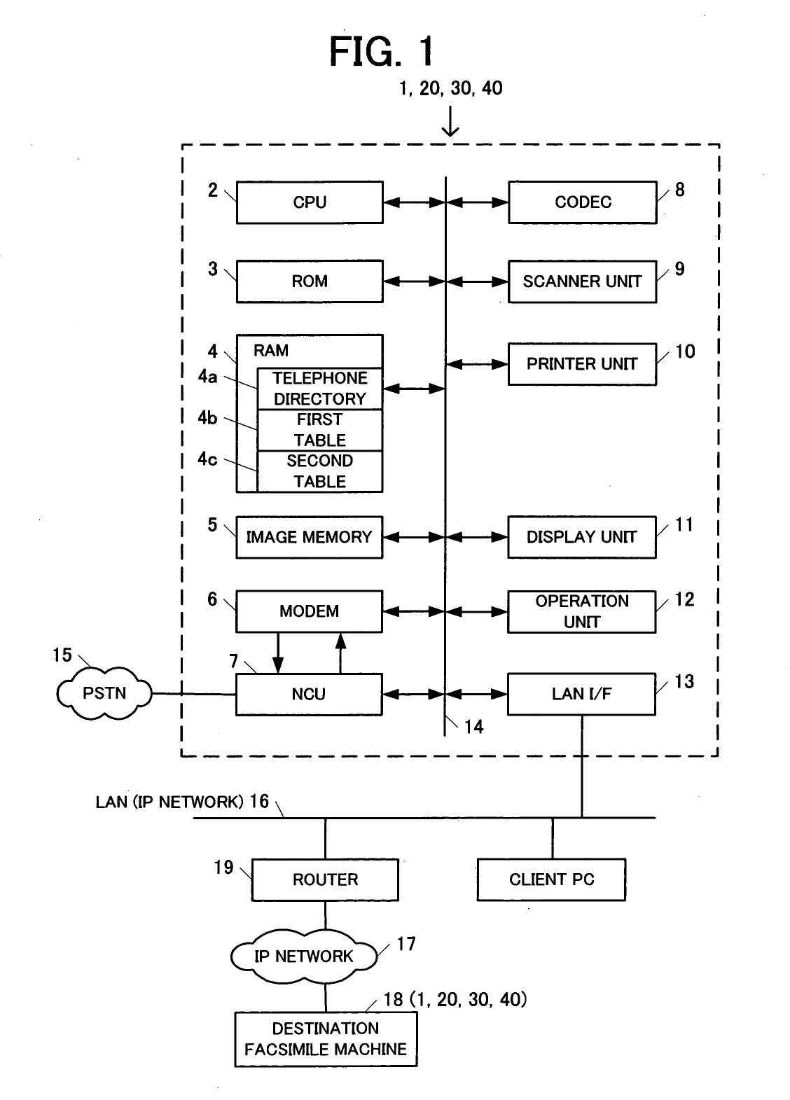

FIG. 1 shows an example of a configuration of a facsimile machine 1. The facsimile machine 1 includes a Central Processing unit (CPU) 2, a Read Only Memory (ROM) 3, a Random Access Memory (RAM) 4, an image memory 5, a modem 6, a Network Control Unit (NCU) 7, a codec 8, a scanner unit 9, a printer unit 10, a display unit 11, an operation unit 12 and a Local Area Network (LAN) interface 13. Each of the units 2 through 13 is connected via a bus 14.

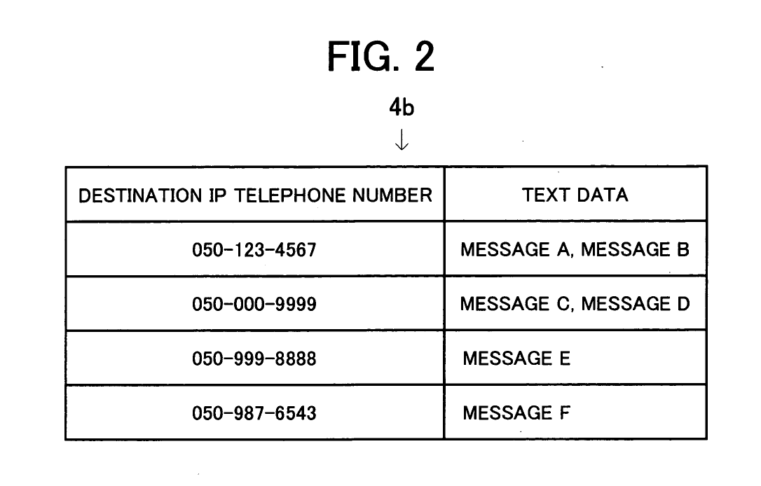

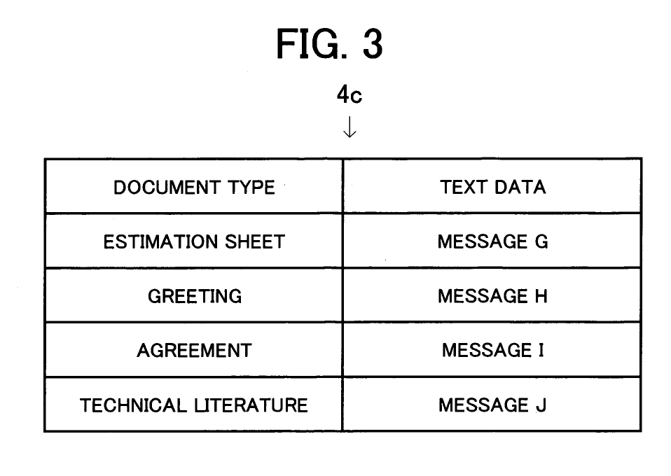

The CPU 2 functions as a control unit which controls each of the units of the facsimile machine 1 in accordance with a control program stored in the ROM 3. The RAM 4 functions as a main memory and a working area or the like of the CPU 2. The RAM 4 stores a telephone directory 4a, which stores a destination facsimile number, a destination IP telephone number or the like associated with a speed dial number or a one-touch key. Furthermore, in the RAM 4, text data is registered by being associated with destination IP telephone number (destination information) or a type of a transmission original document (a type of transmission image data). For example, a first table 4b, which registers (stores) text data for each destination IP telephone number as shown in FIG. 2, and a second table 4c, which registers (stores) text data for each type of a transmission original document as shown in FIG. 3, are formed in the RAM 4. Further, “MESSAGE A”, “MESSAGE B”, etc. shown in a “TEXT DATA” column of the first table 4b and the second table 4c represent text data registered arbitrarily by a user.

The image memory 5 stores image data or the like compressed and encoded by the codec 8. The modem 6 modulates and demodulates transmission data and received data in accordance with, for example, the ITU-T recommendation V.34 standard or anything similar to this. The NCU 7 is a network control device, which carries out a closing operation and a releasing operation of a communication line with a Public Switched Telephone Network (PSTN) 15. Then NCU 7 connects the modem 6 to the PSTN 15 at transmission and reception of G3 facsimile. In case of carrying out a facsimile transmission or the like, the codec 8 compresses and encodes image data by the Joint Photographic Experts Group (JPEG) method or the Modified Huffman (MH), the Modified Read (MR) or the Modified Modified Read (MMR) method or the like. The codec 8 decodes received image data or the like.

The scanner unit 9 scans image data of an original document. For example, the scanner unit 9 includes a Charge Coupled Device (CCD) color line sensor, an Analog-to-Digital (A/D) converter and an image processing circuit or the like. The printer unit 10 picks up printing paper from a paper feed cassette and prints received image data, scanned image data or the like onto the printing paper. The display unit 11 is, for example, a Liquid Crystal Display (LCD) provided in proximity to the operation unit 12. The display unit 11 displays various pieces of screen information. The operation unit 12 includes various operation keys such as a start key, a character entry key and a function key. The user carries out various operations from the operation unit 12.

The LAN interface 13 is an interface for establishing a connection between the facsimile machine 1 and a LAN 16. The facsimile machine 1 carries out communication through the LAN 16 with a client Personal Computer (PC), a router 19 or the like, which are also connected to the LAN 16. The facsimile machine 1 also carries out IP facsimile communication using the SIP through the router 19 with a facsimile machine 18, which is provided on an IP network 17 and is similar to the facsimile machine 1.

The above-described facsimile machine 1 is embedded with the Transmission Control Protocol/Internet Protocol (TCP/IP), the SIP, the Real-time Transport Protocol (RTP), the Session Description Protocol (SDP) or the like. The facsimile machine 1 establishes a media session by the SIP and, for example, transmits and receives image data of an original document to and from a destination by the RTP. The facsimile machine 1 also includes a function for transmitting and receiving text data to and from a destination by using a SIP method “MESSAGE”. The communication protocol for transmitting and receiving image data is not limited to the RTP. Instead of the RTP, the Simple Mail Transfer Protocol (SMTP), the Hyper Text Transfer Protocol (HTTP) or the like can be used for the communication protocol.

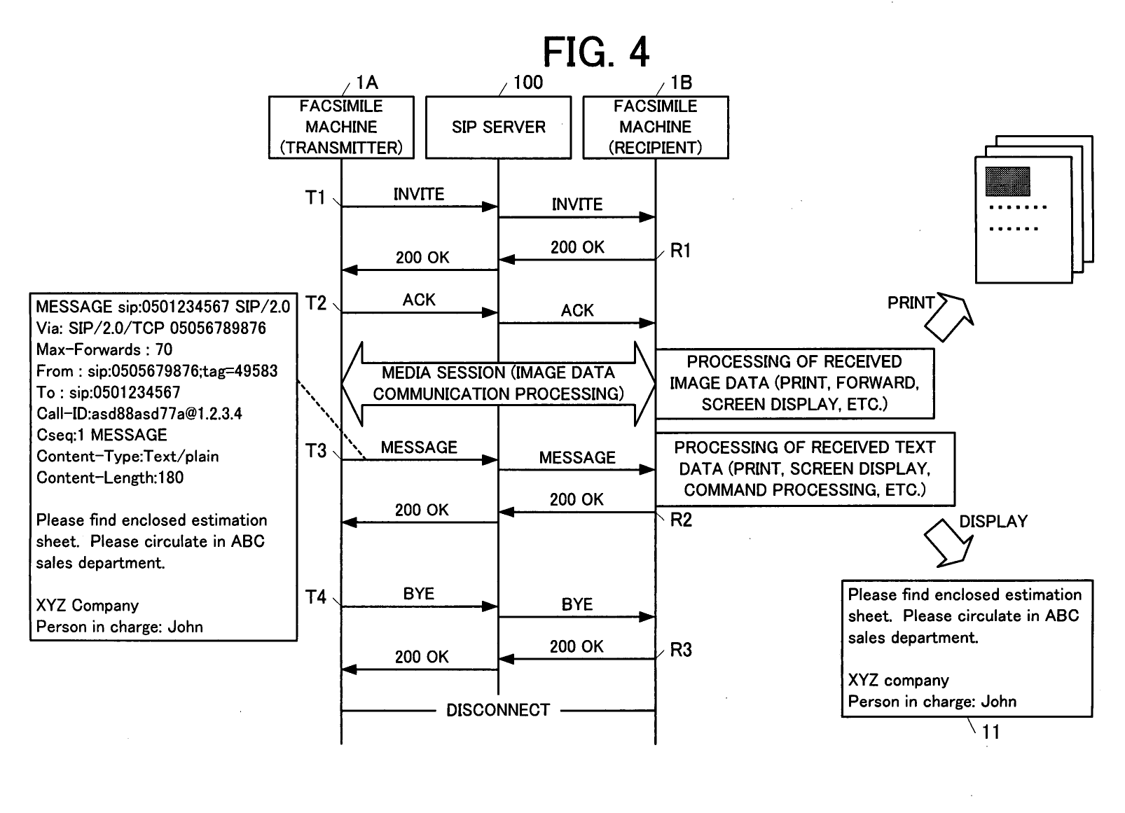

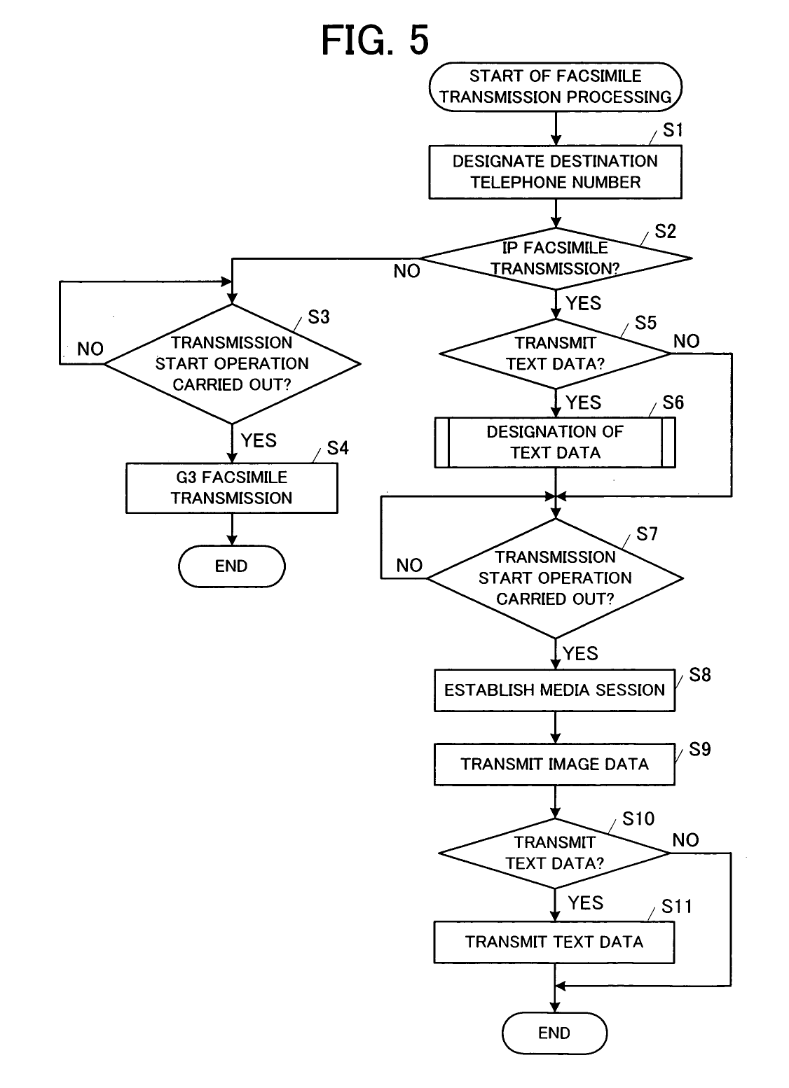

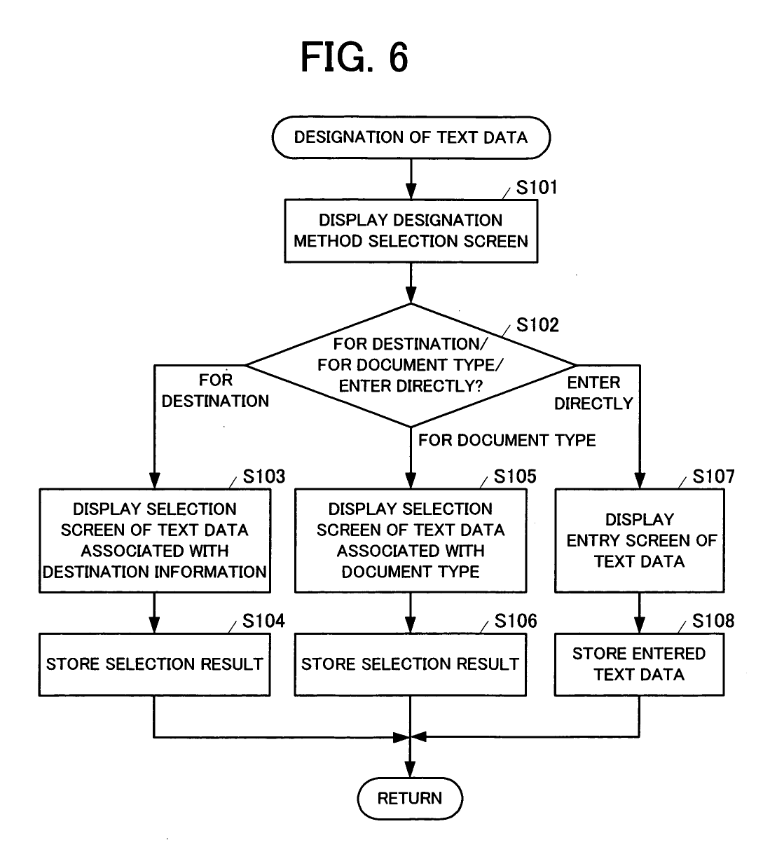

Next, referring to the sequence diagram shown in FIG. 4 and the flowcharts shown in FIG. 5 and FIG. 6, a description will be made of a processing operation when the facsimile machine 1 having the above-described configuration and communication function transmits image data and text data by the IP facsimile communication with a facsimile machine having the same configuration and the same communication function as the facsimile machine 1. Further, each processing operation of the facsimile machine 1 to be described with reference to these drawings is executed by following a command generated by the CPU 2, which is a control unit, in accordance with a control program stored in the ROM 3. In the following, for convenience of the description, the facsimile machine 1 to be a caller side will be referred to as a transmitter 1A and the facsimile machine 1 to be a called side will be referred to as a recipient 1B.

First, referring to the sequence diagram of FIG. 4, a description will be made of a communication procedure when image data and text data are transmitted and received between the transmitter 1A and the recipient 1B by the IP facsimile communication. In case a transmission operation is carried out at the transmitter 1A, a call control session for establishing a media session as shown in the drawing is formed between the transmitter 1A and the recipient 1B. That is, the transmitter 1A requests a SIP server 100, a call of the recipient 1B by a session participation request “INVITE”, which designates an IP telephone number of the recipient 1B (T1). The SIP server 100, which received “INVITE”, inquires a location server (not shown), which has information that associates an IP telephone number and an IP address, as to an IP address associated with the IP telephone number designated by the transmitter 1A. Then, the SIP server 100 carries out a call by transmitting “INVITE” received from the transmitter 1A to the acquired IP address of the recipient 1B. When the recipient 1B responds to the call from the SIP server 100, the recipient 1B receives “INVITE” and transmits a success response code “200 OK” to the SIP server 100 (R1). The transmitter 1A, which received the success response code “200 OK”, transmits information “ACK” indicating the reception of the success response code “200 OK” via the SIP server 100 to the recipient 1B (T2). Then, a media session is established between the transmitter 1A and the recipient 1B and image data is transmitted from the transmitter 1A to the recipient 1B.

While the media session is established, the text data designated by the user (a designation of the text data will be described later) is transmitted to the recipient 1B by the SIP method “MESSAGE” under a timing independent from the transmission processing of the image data in the media session (T3). That is, the text data designated by the user is transmitted to the recipient 1B by the SIP method “MESSAGE” at the same time as the transmission processing of the image data or before or after the transmission processing of the image data. Further, if the SIP method can transmit any designated text data to a destination, the SIP method is not limited to the above-described example and another method can be used.

The recipient 1B executes a prescribed processing on each of the image data and the text data received from the transmitter 1A, respectively. For the received image data, for example, the recipient 1B executes a print processing, a forward processing, a screen display processing or the like. For the received text data, for example, the recipient 1B executes a print processing, a screen display processing or the like. Moreover, the recipient 1B can previously store text data and a specific processing operation by associating with one another and execute a corresponding processing operation by regarding the received text data as a command.

When the transmission processing of the image data and the text data from the transmitter 1A to the recipient 1B is completed, the transmitter 1A transmits “BYE” requesting an end of the session via the SIP server 100 to the recipient 1B (T4). The recipient 1B transmits a success response code “200 OK” via the SIP server 100 to the transmitter 1A (R3). Then, the communication is disconnected.

Next, referring to the flowcharts shown in FIG. 5 and FIG. 6, the above-described processing operation of the transmitter 1A will be described in more detail.

At the transmitter 1A, a destination telephone number (destination information) is designated by being entered directly or is designated by using a speed dial function or a one-touch dial function (S1). Then, the transmitter 1A determines whether to carry out the IP facsimile transmission or whether to carry out the G3 facsimile transmission in accordance with the designated destination telephone number (S2). The determination is carried out, for example, in accordance with a specific digit of the telephone number.

In case a determination is made to carry out the G3 facsimile transmission (S2: NO), after a transmission start operation is carried out (for example, after the start key is pressed) (S3: YES), the transmitter 1A transmits the image data of the original document to a destination device having the designated telephone number by the G3 facsimile communication (S4).

In case a determination is made to carry out the IP facsimile transmission (S2: YES), the transmitter 1A executes a processing operation for requesting the user as to an instruction of whether or not to transmit the text data. For example, the transmitter 1A displays an inquiry such as “Transmit text data?” and accepts a positive/negative instruction operation for the inquiry display (for example, an entry of Y/N from the operation unit 12). In case a positive instruction operation is carried out and a determination is made to transmit the text data (S5: YES), the text data is designated by a prescribed operation of the user (S6).

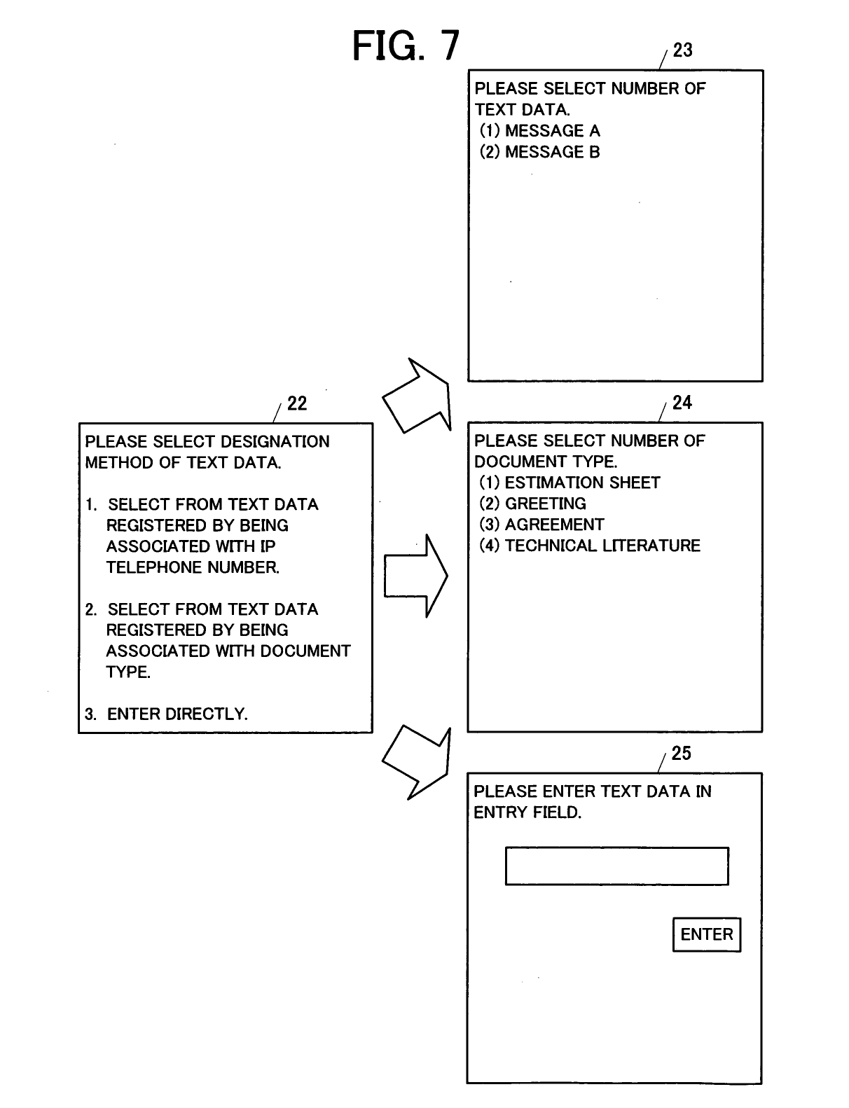

The designation of the text data by the user is carried out by selecting from the text data registered in the first table 4b by being associated with the IP telephone number designated at S1, selecting from the text data registered in the second table 4c by being associated with a type of the original document or by directly entering a character or the like by the user. More specifically, after the transmitter 1A makes a positive determination at S5, the transmitter 1A displays on the display unit 11, a screen 22 for selecting a designation method of the text data as shown in FIG. 7 (S101). The screen 22 displays selectable items such as “Select from text data registered by being associated with IP telephone number.”, “” Select from text data registered by being associated with document type.” and “Enter directly.” When either one of the items is selected by a prescribed operation, a corresponding screen 23, 24 or 25 is displayed on the display unit 11.

In case the item displayed as “Select from text data registered by being associated with IP telephone number.” is selected (S102: for destination), the display unit 11 displays the text data selection screen 23, which displays the text data stored in the first table 4b by being associated with the IP telephone number designated at S1 in a manner that the text data can be selected (S103). When either one of the text data displayed on the text data selection screen 23 is selected by a prescribed operation, the selection result is stored in the RAM 4 until the text data is transmitted later (S104).

In case the item displayed as “Select from text data registered by being associated with document type.” is selected (S102: for document type), the display unit 11 displays the document type selection screen 24, which displays document types registered in the second table 4c in a manner that a document type can be selected (S105). When either one of the document types displayed on the document type selection screen 24 is selected by a prescribed operation, the selection result is stored in the RAM 4 until the text data is transmitted later (S106).

In case the item displayed as “Enter directly. “is selected (S102: enter directly), for example, the display unit 11 displays the text data entry screen 25 as shown in the drawing (S107). When the text data is entered directly by a key operation or the like of the operation unit 12, the entered text data is stored until the text data is transmitted later (S108).

After the processing operation of S6 is executed or after a negative determination is made at S5, when a transmission start operation is carried out (for example, when the start key is pressed) (S7), the transmitter 1A forms the call control session of T1, T2 or the like with the recipient 1B and establishes a media session (S8). Then, the transmitter 1A carries out a transmission processing of the image data of the original document (S9). The image data of the original document to be transmitted is, for example, image data of an original document scanned by the scanner unit 9, image data received from the client PC along with a facsimile transmission command or image data accumulated previously in the facsimile machine 1.

In case a positive determination is made at S5 (S10: YES), the designated text data to be transmitted is retrieved in accordance with the selection result or the entered text data stored at S104, S106 or S108. That is, in case the processing operation of S104 is executed, the text data selected from the text data associated with the selected destination IP telephone number is transmitted to the recipient 1B by the SIP method “MESSAGE” as the designated text data (S11). In case the processing operation of S106 is executed, the text data associated with the selected document type (the type of the image data) is transmitted to the recipient 1B by the SIP method “MESSAGE” as the designated text data (S11). In case the processing operation of S108 is executed, the entered text data is transmitted to the recipient 1B by the SIP method “MESSAGE” as the designated text data (S11). Then, the transmitter 1A transmits “BYE” requesting an end of the session and disconnects the communication with the recipient 1B. Meanwhile, in case a negative determination is made at S5 (S10: NO), the transmitter 1A transmits “BYE” without carrying out the processing operation of S11 and disconnects the communication (T4).

Further, in the present embodiment, after the transmission processing of the image data of S9 is carried out, the transmission processing of the text data of S11 is carried out. However, before carrying out the transmission processing of the image data of S9, the processing operations of S10 and S11 can be carried out to carry out the transmission processing of the text data. Alternatively, while carrying out the transmission processing of the image data of S9, the processing operations of S10 and S11 can be carried out to transmit the text data.

In the present embodiment, the text data is stored by being associated with the destination IP telephone number or the document type. However, a plurality of text data can be registered in a prescribed area of the RAM 4 in an independent form without being associated with other information, and at S6, a plurality of the registered text data can be displayed on the display unit 11 in a manner that text data can be selected, and at S1, the selected text data can be transmitted as the designated text data to be transmitted.

### Second Embodiment

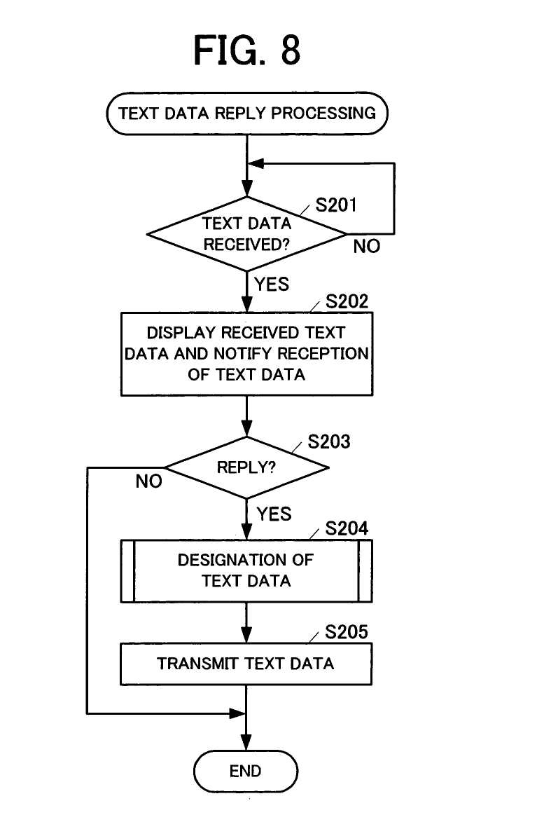

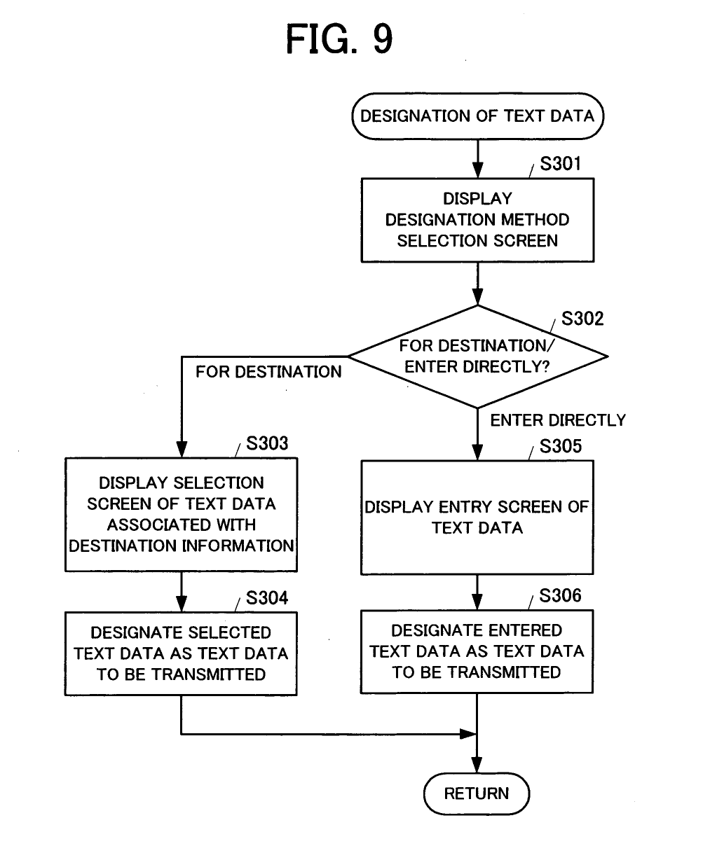

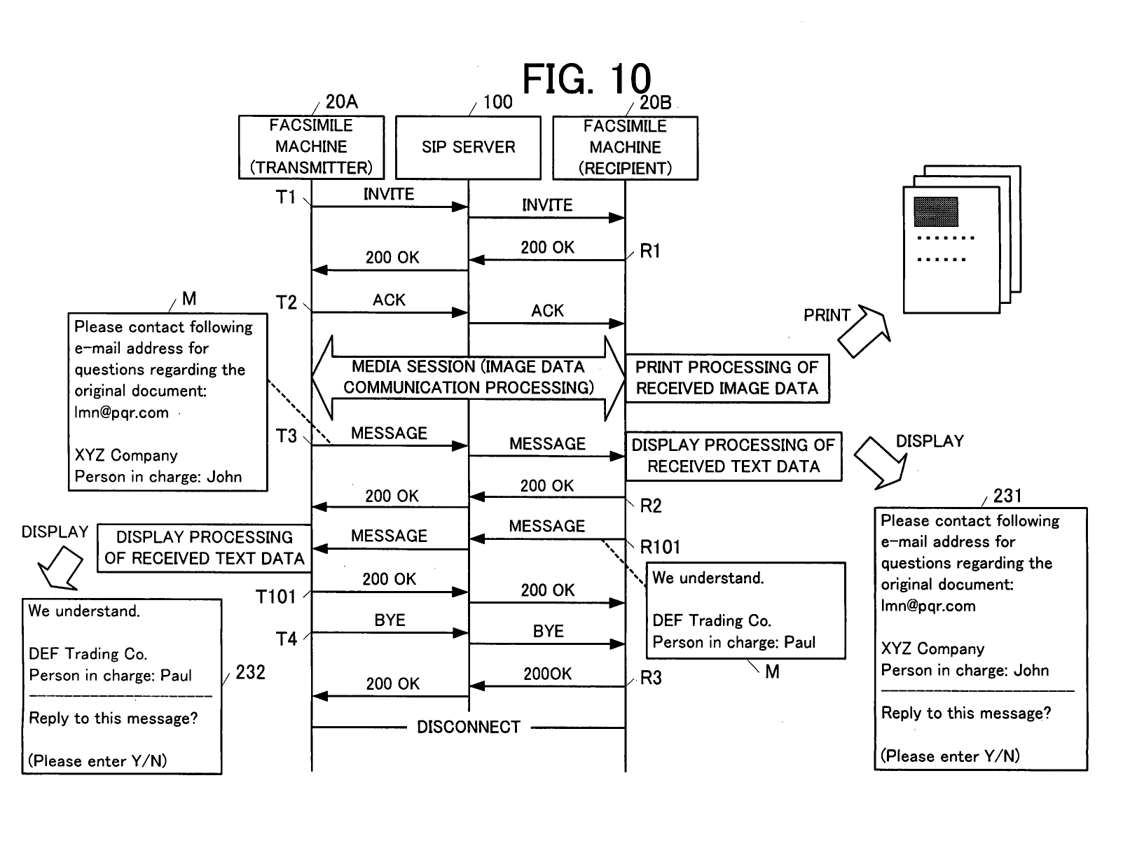

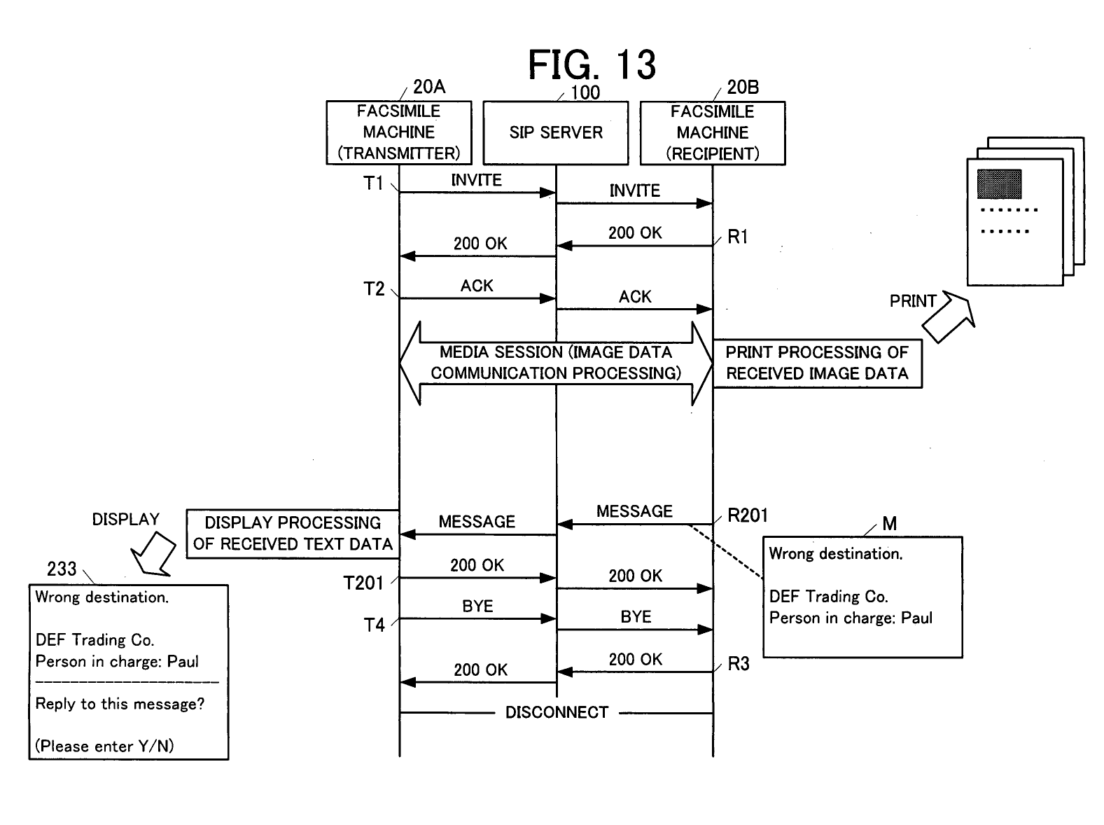

Referring to the flowcharts shown in FIG. 8 and FIG. 9 and the sequence diagram shown in FIG. 10, a description will be made of a facsimile machine according to a second embodiment of the present invention. In the following, a difference with respect to the facsimile machine of the first embodiment will be described mainly. For the configuration and the processing operation that are the same as the facsimile machine of the first embodiment, the same reference numeral will be applied in the drawing and the description will be omitted. Further, for convenience of the description, also in the second embodiment, a facsimile machine 20 to be a caller side will be referred to as a transmitter 20A and a facsimile machine 20 to be a called side will be referred to as a recipient 20B. In a content M of the text data shown in FIG. 10 and FIG. 13, header information is omitted due to space limitations of the drawings.

When the recipient 20B receives text data by the SIP method “MESSAGE” from the transmitter 20A at T3 (S201: YES), the recipient 20B returns a response code “200 OK” (R2) and carries out a display of the received text data and a notification of the reception of the text data (S202). The display of the received text data is carried out by extracting the text data received by “MESSAGE” and displaying the extracted text data on the display unit 11 as shown in a screen 231 of FIG. 10. The notification is sufficient if the reception of the text data is notified to the user. For example, a sound generator (not shown), which generates a specific notification sound, can be provided in the facsimile machine 20 and when receiving the text data, in other words, when receiving “MESSAGE”, the notification sound can be generated. Alternatively, the notification can be carried out by flashing the text data (the screen 231) displayed on the display unit 11. By carrying out the notification operation in the above-described manner, the reception of the text data can be notified more clearly to the user.

Next, the recipient 20B executes a processing operation for requesting the user as to an instruction of whether or not to reply to the transmitter 20A, which is the transmitter of the text data. For example, the recipient 20B displays the screen 231 shown in FIG. 10, which displays the received text data and an inquiry such as “Reply to this message?”, and accepts a positive/negative instruction operation for the inquiry display (for example, an entry of Y/N from the operation unit 12). In case a positive instruction operation is carried out and a determination is made to reply the text data (S203: YES), the text data is designated by a prescribed operation of the user to be described later (S204). In case a negative instruction operation is carried out (S203: NO), a series of the processing operations is ended without replying the text data.

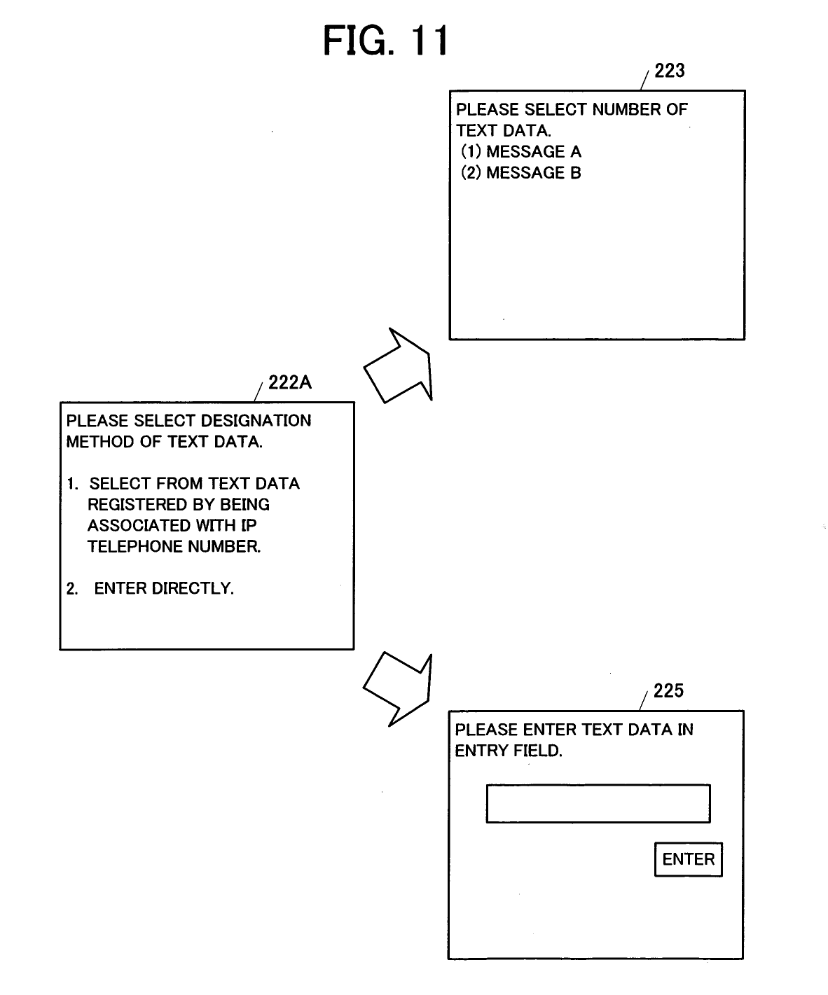

The designation of the text data by the user of S204 is carried out by selecting from the text data registered in the first table 4b by being associated with the IP telephone number of the transmitter 20A, which is the transmitter of the text data, or by entering character information or the like directly by the user. Specifically, after the positive determination is carried out at S203, the recipient 20B displays on the display unit 11, a screen 222A as shown in FIG. 11 for selecting a designation method of the text data (S301). The screen 222A displays selectable items such as “Select from text data registered by being associated with IP telephone number.” and “Enter directly.” When either one of the items is selected by a prescribed operation, a corresponding screen 223 or 225 to be described later is displayed on the display unit 11.

In case the item displayed as “Select from text data registered by being associated with IP telephone number” is selected (S302: for destination), the display unit 11 displays the text data selection screen 223, which displays the text data stored in the first table 4b by being associated with the IP telephone number of the transmitter 20A, which is the transmitter of the text data received at S201, (the IP telephone number is acquired at the reception of “INVITE”) in a manner that text data can be selected (S303). When either one of the text data displayed on the text data selection screen 223 is selected by a prescribed operation, the recipient 20B designates the selected text data as the text data to be transmitted (replied) (S304). The recipient 20B returns the designated text data to the transmitter of the text data received at S201 by the SIP method “MESSAGE”, in other words, to the transmitter 20A (S205, R101). Further, the destination information (an IP address, an IP telephone number, etc.) of the transmitter is acquired at S201 along with the text data and is stored temporarily in a storage unit such as the RAM. In the reply processing of S205, the destination information is retrieved and designated as a reply destination.

Meanwhile, in case the item displayed as “Enter directly.” is selected (S302: enter directly), for example, the display unit 11 displays the text data entry screen 225 as shown in the drawing (S305). When the text data is entered directly in the text data entry screen 225 by a key operation or the like of the operation unit 12, the recipient 20B designates the entered text data as the text data to be transmitted (replied) (S306). The recipient 20B returns the designated text data to the transmitter of the text data received at S201 by the SIP method “MESSAGE”, in other words, to the transmitter 20A (S205, R101). Further, as described above, the information acquired at S201 is stored temporarily in the storage unit as the destination information of the transmitter. In the reply processing of S205, the destination information is retrieved and designated as the reply destination.

When the transmitter 20A receives the text data transmitted from the recipient 20B at R101, the transmitter 20A returns the response code “200 OK” (T101) and executes the processing operations of S201 and onwards. That is, the transmitter 20A displays the text data received from the recipient 20B on the display unit 11, for example, as a screen 232 shown in FIG. 10. Then, when the user of the transmitter 20A carries out a text data designation operation or the like for replying to the received text data (S203: YES, S301 through S306), the designated text data is returned to the recipient 20B (S205; the processing operation is not shown in FIG. 10).

Further, in FIG. 10, the transmission and the reception of the image data, the transmission and the reception of the text data by the SIP method “MESSAGE” (T3, R101) and the transmission and the reception of the SIP method “BYE” (T4) are shown in this order. However, FIG. 10 just shows an example of the communication procedure and the communication procedure is not limited to the example shown in the drawing. For example, prior to the transmission and the reception of the image data, the transmission and the reception of the text data by the SIP method “MESSAGE” can be carried out. Alternatively, after the SIP method “BYE” is transmitted and the media session is ended, the SIP method “MESSAGE” can be exchanged.

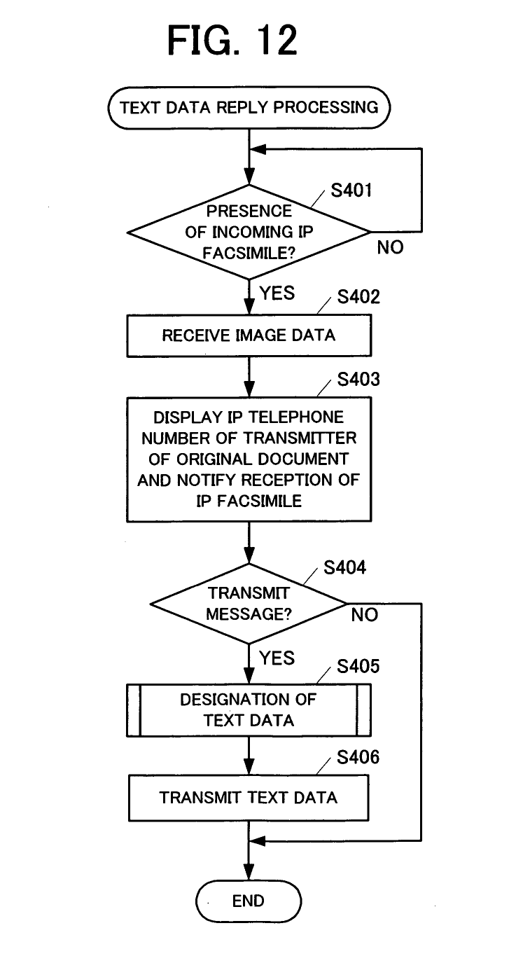

Next, referring to the flowchart shown in FIG. 12 and the sequence diagram shown in FIG. 13, a description will be made of a processing operation when the recipient 20B receives only the image data and does not receive text data.

When the recipient 20B receives an incoming IP facsimile, in other words, when the recipient 20B receives “INVITE” transmitted from the transmitter 20A at T1 (S401: YES), the recipient 20B establishes a media session with the transmitter 20A and carries out a reception processing (for example, a print processing) of the image data (S402). Then, the recipient 20B displays on the display unit 11, the IP telephone number of the transmitter 20A received along with “INVITE” at S401, and carries out a notification of the reception of the IP facsimile (S403). The notification is sufficient if the reception of the IP facsimile is notified to the user. For example, a sound generator (not shown), which generates a specific notification sound, can be provided in the facsimile machine 20 and when receiving “INVITE” or the image data, the notification sound can be generated. Alternatively, the notification can be carried out by flashing the display of the display unit 11. Accordingly, the reception of the IP facsimile and the IP telephone number of the destination can be notified timely to the user.

Next, as the processing operation for requesting the user as to an instruction of whether or not to transmit a message to the transmitter 20A, the recipient 20B displays an inquiry such as “Transmit a message to the transmitter of the original document?” and accepts a positive/negative instruction operation for the inquiry display (for example, an entry of Y/N from the operation unit 12). Then, in case a positive instruction operation is carried out and a determination is made to transmit the text data (S404: YES), the text data is designated by a prescribed operation of the user (S405). The designation of the text data is carried out by executing the processing operation similar to the processing operation of S204, in other words, the processing operations of S301 through S306. Then, the text data designated as the text data to be transmitted is transmitted to the transmitter 20A by the SIP method “MESSAGE” (S406, R201). At S404, in case a negative instruction operation is carried out and a determination is made not to transmit the text data, a series of the processing operations is ended.

When the transmitter 20A receives the text data transmitted from the recipient 20B at R201, the transmitter 20A returns a response code “200 OK” (T201) and executes the processing operations of S201 and onwards shown in FIG. 8. That is, the transmitter 20A displays the text data received from the recipient 20B on the display unit 11, for example, as a screen 233 shown in FIG. 13, and notifies the reception of the text data (S202). Then, the transmitter 20A displays an inquiry such as “Reply to this message?” on the screen 233 and accepts a positive/negative instruction operation for the inquiry display (for example, an entry of Y/N from the operation unit 12). In case a positive instruction operation is carried out by the user, a determination is made to reply the text data (S203: YES). Then, the above-described designation processing of the text data is carried out by a prescribed operation of the user (S204, S301 through S306; the processing operation is not shown in FIG. 13) and the designated text data is transmitted to the recipient 20B. Meanwhile, in case anegative instruction operation is carried out at the transmitter 20A (S203: NO), a series of the processing operations is ended without replying the text data.

Further, in FIG. 13, the transmission and the reception of the image data, the transmission and the reception of the text data by the SIP method “MESSAGE” (R201) and the transmission and the reception of the SIP method “BYE” (T4) are shown in this order. However, FIG. 13 shows just one example of the communication procedure and the communication procedure is not limited to the example shown in the drawing. For example, prior to the transmission and the reception of the image data, the transmission and the reception of the text data by the SIP method “MESSAGE” can be carried out. Alternatively, after the SIP method “BYE” is transmitted and the media session is ended, the SIP method “MESSAGE” can be exchanged.

As described above, according to the facsimile machine 20 of the second embodiment, while transmitting and receiving the image data of the original document, the text data can be exchanged with the destination for any number of times. Since the user is not required to designate location information such as the IP telephone number of the destination when carrying out a reply operation, the operation is simplified.

Moreover, even in case the recipient does not receive the text data from the transmitter, the recipient can return the text data by a simple operation. Accordingly, for example, as shown in FIG. 13, in case the recipient receives image data of an original document due to a wrong destination, the recipient can notify such a fact to the transmitter of the original document by character information.

### Third Embodiment

Next, referring to the drawings, a description will be made of a facsimile machine according to a third embodiment of the present invention. The facsimile machine of the third embodiment has the same configuration and the same communication function as the facsimile machine of the first embodiment. Furthermore, the facsimile machine of the third embodiment includes a function for instructing a recipient facsimile machine as to a processing of image data of an original document to be transmitted in a media session by the SIP. That is, in the facsimile machine of the third embodiment, a command indicating a processing to be executed on the image data of the original document to be transmitted in the media session can be designated according to an operation of the user. The facsimile machine of the third embodiment transmits the image data of the original document and transmits the designated text format command to the same destination by the SIP method “MESSAGE”. Meanwhile, the recipient facsimile machine detects the command from the text data received by the SIP method “MESSAGE” and executes a processing corresponding to the command on the image data of the original document received from the same transmitter. Further, also in the third embodiment, the SIP method for transmitting the text data (the text data including the command) is not limited to “MESSAGE”. If the SIP method can transmit any text data designated by the user, another type of method can be used.

In the following, with reference to the drawings, a detailed description will be made of a processing operation when a facsimile machine 30 transmits and receives image data according to the third embodiment. Further, for the configuration and the processing operation that are the same as the facsimile machine of the first embodiment, the same reference numeral is applied in the drawing and the description will be omitted. For convenience of the description, also in the third embodiment, a facsimile machine 30 to be a caller side will be referred to as a transmitter 30A and a facsimile machine 30 to be a called side will be referred to as a recipient 30B.

In the facsimile machine 30, a command associated with each of various processing to be executed on image data of an original document is set (stored) previously. Specifically, in the facsimile machine 30, a text format command such as a “printing instruction”, a “FAX forwarding instruction”, a “bulletin board accumulating instruction” and a “circulating instruction” is set. The “printing instruction” is a command indicating to print received image data. The “FAX forwarding instruction” is a command indicating to forward the received image data by the G3 facsimile. The “bulletin board accumulating instruction” is a command indicating to accumulate the received image data in an electronic bulletin board. The “circulating instruction” is a command indicating to circulate the received image data. Further, as a command indicating a destination of the operation, a “forwarding destination” is attached to the “FAX forwarding instruction” and a “circulation destination” is attached to the “circulating instruction”.

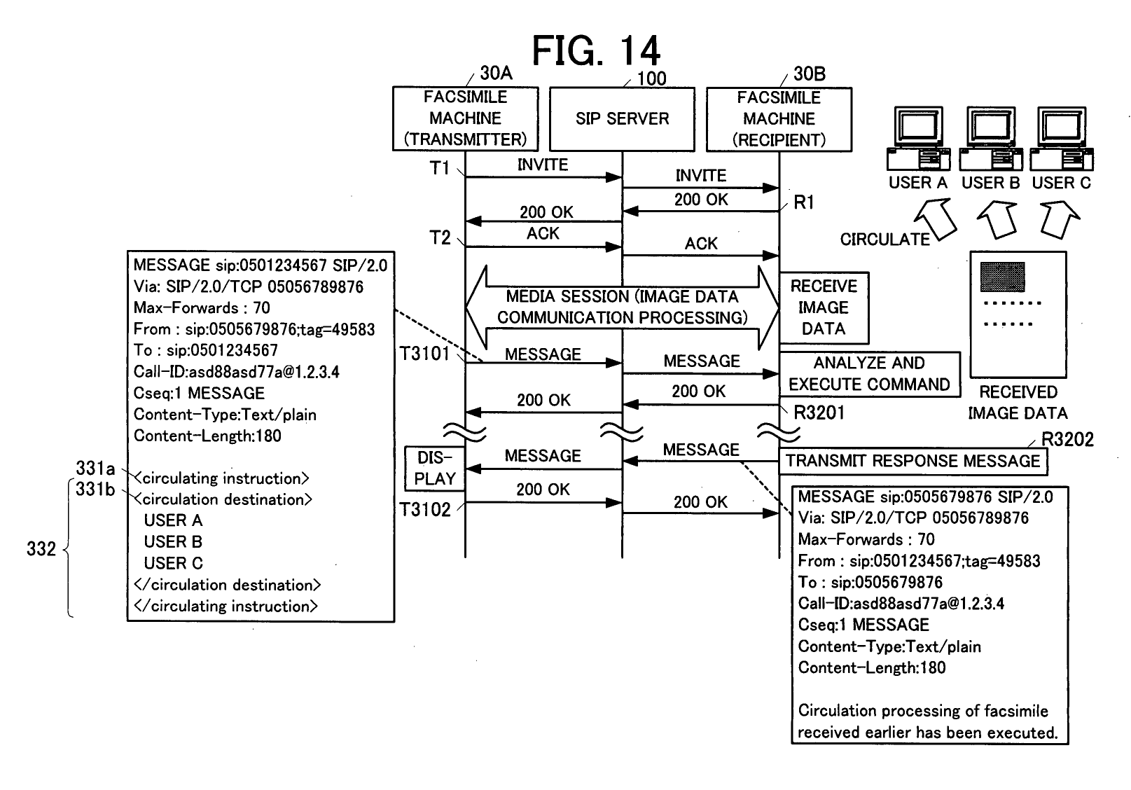

FIG. 14 shows a procedure formed when the transmitter 30A and the recipient 30B transmit and receive image data and a command. As shown in the drawing, after the image data of the original document is transmitted from the transmitter 30A to the recipient 30B in the established media session (the procedure shown in FIG. 14 is an example, and can be before the transmission or during the transmission of the image data of the original document), under a timing independent from the transmission processing of the image data, while the media session is established, the transmitter 30A transmits commands 331a and 331b designated by an operation of the user to the recipient 30B by the SIP method “MESSAGE”. As shown in FIG. 14, in text data 332 transmitted from the transmitter 30A to the recipient 30B by the SIP method “MESSAGE”, the commands 331a and 331b are described under a specific format so that the commands can be distinguished from other information. That is, the transmitter 30A transmits text data in which a command is surrounded by specific symbols “<” and “>”. The recipient 30B, which received this text data, extracts a part surrounded by the specific symbols and executes a processing corresponding to the command. For example, as shown in the drawing, in case the commands are the “circulating instruction” and the “circulation destination”, the recipient 30B circulates the image data received from the transmitter 30A in the media session to destination information “USER A”, “USER B” and “USER C” instructed by the command “circulation destination”. Further, in the example shown in FIG. 14, each piece of information described with linefeed between “<circulation destination>” and “</circulation destination>” is extracted by the recipient 30B as the destination information, respectively. The information described between “<circulating instruction>” and “</circulating instruction>” is processed as information relating to the command “circulating instruction”. Of course, a description format or the like of the command is not limited to the above-mentioned example and can be defined previously between the transmitter 30A and the recipient 30B.

After the processing for the image data is completed, the recipient 30B transmits text data indicating such a fact, for example, “Circulation processing of facsimile received earlier has been executed”, to the transmitter 30A by the SIP method “MESSAGE”. Then, the transmitter 30A displays the text data. Accordingly, the user of the transmitter 30A can learn a fact that the command processing has been completed at the recipient 30B.

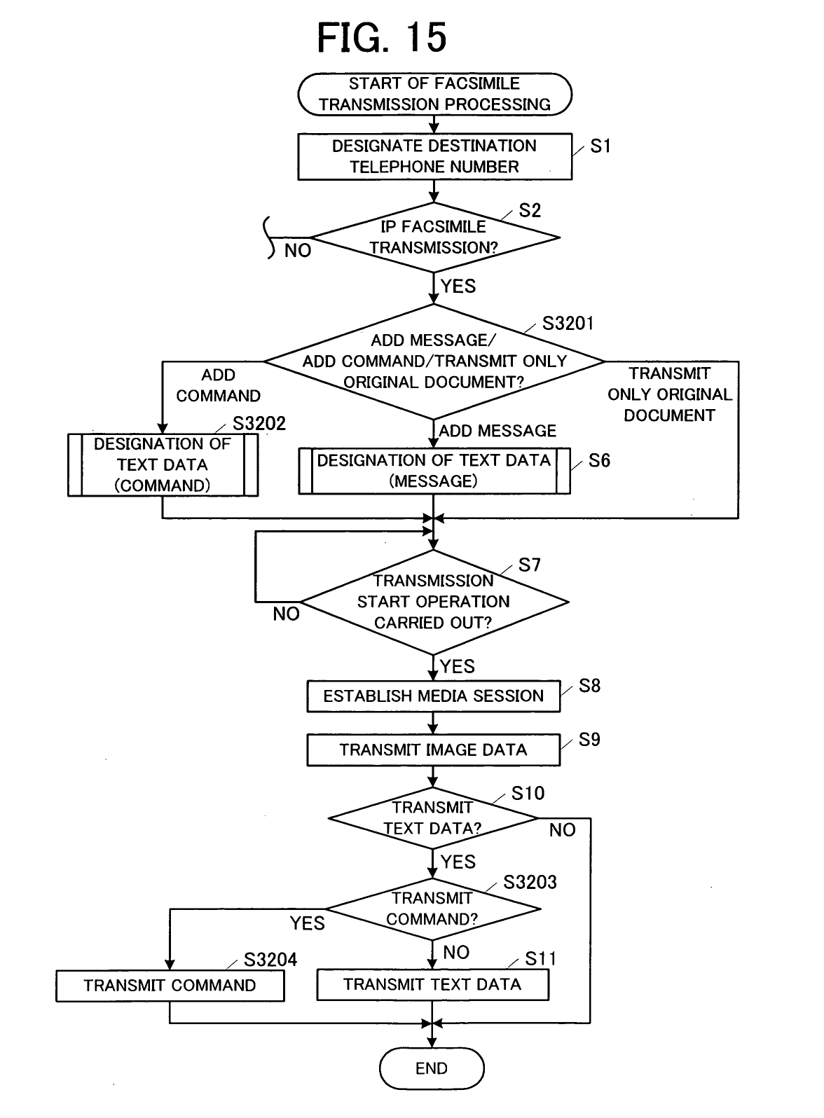

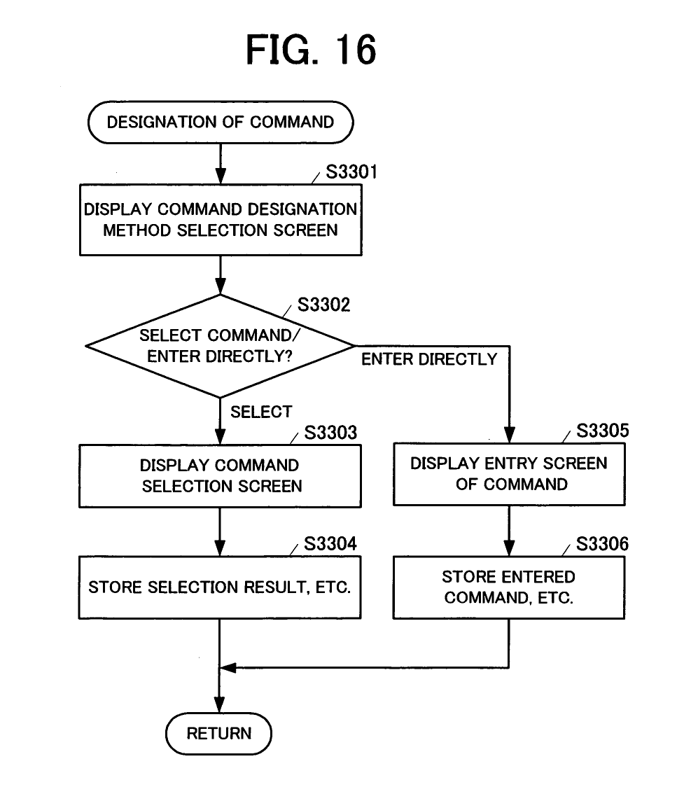

Referring to the flowcharts shown in FIG. 15 and FIG. 16, a detailed description will be made of the processing operation of the above-described transmitter 30A.

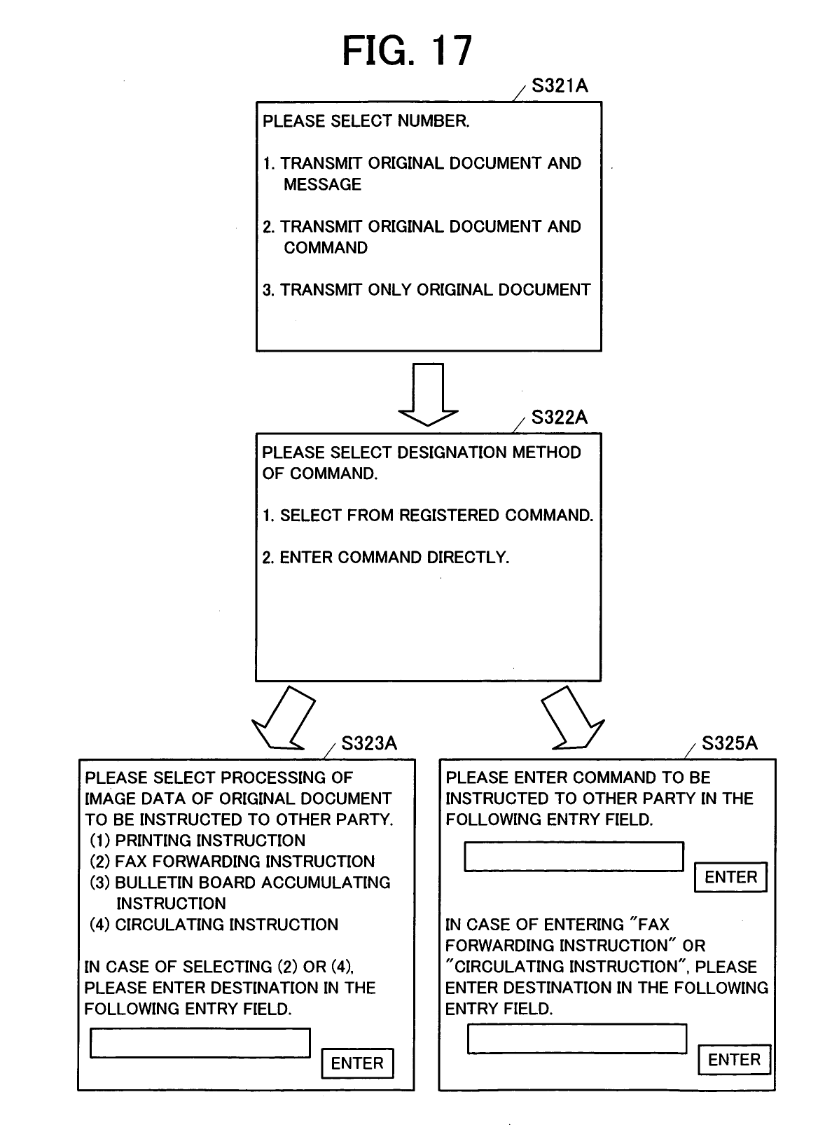

At the transmitter 30A, in case a facsimile transmission operation is carried out by the user and a determination is made at S2 that the designated destination telephone number (destination information) is an IP telephone number (S2: YES), a processing operation is carried out for requesting the user as to an instruction of whether to transmit a message along with the image data of the original document, whether to transmit a command along with the image data of the original document or whether to transmit only the image data of the original document. For example, a screen 321A as shown in FIG. 17 is displayed on the display unit 11. The screen 321A displays selectable items such as “Transmit original document and message”, “Transmit original document and command” and “Transmit only original document”. When either one of the items is selected by a prescribed operation, a corresponding screen is displayed on the display unit 11.

In case “Transmit original document and message” is selected, the transmitter 30A determines to transmit a message along with the image data of the original document (S3201: add message). Then, the process proceeds onto S6 and the processing operations of S101 through S108 described in the first embodiment are carried out.

In case “Transmit original document and command” is selected, the transmitter 30A determines to transmit a command along with the image data of the original document (S3201: add command). The transmitter 30A executes a processing operation for designating a text format command indicating a processing to be executed on the image data of the original document to be transmitted (S3202). The designation of the command is carried out by selecting from a plurality of commands set previously in the facsimile machine 30 or by entering a character or the like of the command by the user. Specifically, the transmitter 30A displays on the display unit 11, a screen 322A as shown in FIG. 17 for selecting a designation method of the command (S3301). The screen 322A displays selectable items such as “Select from registered command.” and “Enter command directly.” When either one of the items is selected by a prescribed operation, a corresponding screen 323A or 325A is displayed on the display unit 11.

In case the item displayed as “Select from registered command.” is selected (S3302: select), as shown in FIG. 17, the display unit 11 displays a plurality of commands set previously in the facsimile machine 30 in a manner that a command can be selected. In addition, the display unit 11 also displays an entry field for entering destination information of a terminal device, which is to be a forwarding destination or a circulation destination, for the forwarding instruction and the circulating instruction (S3303). When either one of the commands displayed on the screen 323A is selected by a prescribed operation, the selection result, and in case the “FAX forwarding instruction” or the “circulating instruction” is selected, the entered destination information are stored in the RAM 4 until the command or the like is transmitted later (S3304).

In case the item displayed as “Enter command directly.” is selected (S3302: enter directly), for example, the display unit 11 displays a command entry screen 325A as shown in the drawing. In addition, the display unit 11 displays an entry field for entering destination information of a terminal device, which is to be a forwarding destination or a circulation destination, for the forwarding instruction and the circulating instruction (S3305). The text format command, and in case the destination information is entered, the destination information, which are entered in the entry fields displayed on the screen 325A by a key operation or the like of the operation unit 12, are stored in the RAM 4 until the command or the like is transmitted later (S3306).

At S3201, in case “Transmit only original document” is selected and the transmitter 30A determines to transmit only the image data of the original document (S3201: transmit only original document), in case the processing operation of S6 is carried out or in case the processing operation of S3202 is carried out, the processing operations of S7 through S9 are executed subsequently.

In case the text data (message) is designated at S6, a determination is made to transmit the text data (S10: YES) and a determination is made not to transmit the command (S3203: NO). Then, the process proceeds onto S11. In accordance with the selection result or the entered text data stored at S104, S106 or S108, the designated text data to be transmitted is retrieved and the retrieved text data is transmitted to the recipient 30B by the SIP method “MESSAGE” (S11).

In case the text data (command) is designated at S3202, a determination is made to transmit the text data (S10: YES) and a determination is made to transmit the command (S3203: YES). In accordance with the selection result or the entered text data (command) stored at S3304 or S3306, the designated text data (command) to be transmitted is retrieved, and in case the destination information is designated, the destination information is also retrieved. Then, the retrieved command and the destination information are formed by a prescribed description format and are transmitted to the recipient 30B by the SIP method “MESSAGE” (S3204) For example, as shown in FIG. 14, the transmitter 30A transmits the text data including the commands, which are formed by attaching the symbols “<” and “>”, “</” and “>” for distinguishing the commands to the retrieved commands, the destination information “USER A” or the like and the commands “<circulation destination>” and “</circulation destination>” indicating a description area of the destination information.

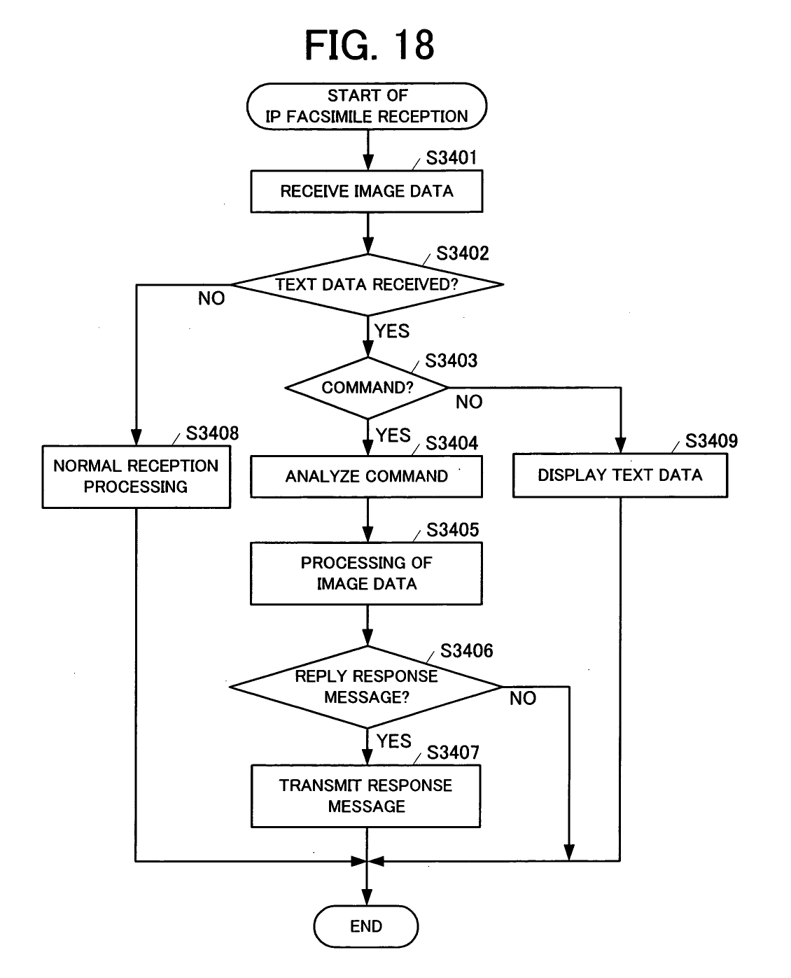

Next, referring to the flowchart shown in FIG. 18, a detailed description will be made of the processing operation of the recipient 30B, which receives the image data of the original document. The recipient 30B receives the image data of the original document from the transmitter 30A in the media session (S3401). When the recipient 30B receives the text data by the SIP method “MESSAGE” (S3402: YES), the recipient 30B determines whether or not a command is included in the received text data (S3403). In case the recipient 30B detects the text data described by the prescribed description format as described above, the recipient 30B determines that a command is included in the received text data (S3403: YES) and analyzes a command surrounded by the symbols “<” and “>” or the like (S3404). Then, the recipient 30B executes a processing associated with the command on the image data of the original document received in the media session (S3405).

For example, in case the command is the “printing instruction” the received image data of the original document is printed onto printing paper by the printer unit 10. In case the command is the “FAX forwarding instruction”, the destination information designated by the command “forwarding destination” is extracted and the received image data of the original document is forwarded by the G3 facsimile to the extracted destination information. In case the command is the “bulletin board accumulating instruction”, the received image data is accumulated in a bulletin board accumulating area (in case the facsimile machine 30 has an electronic bulletin board function, in the bulletin board accumulating area of the facsimile machine 30, and in case an electronic bulletin board accumulating area exists in a remote device, in the electronic bulletin board accumulating area of the remote device) and published. In case the command is the “circulating instruction”, the destination information designated by the command “circulation destination” is extracted and the received image data of the original document is circulated by forwarding to the extracted destination information.

After the processing of the image data of S3405 is carried out, in case a setting of a reply processing of a response message is valid in an apparatus setting or the like of the recipient 30B (S3406: YES), the text data indicating that the command processing has been completed, for example, “Circulation processing of facsimile received earlier has been executed”, is transmitted to the transmitter 30A by the SIP method “MESSSAGE” (S3407, R3).

Meanwhile, in case a negative determination is made at S3402, a normal reception processing such as a print processing and a distribution processing to a prescribed client PC is executed (S3408). In case a negative determination is made at S3403, an output processing of the received text data (for example, a display processing at the display unit 11) is carried out (S3409). At S3406, in case the setting of the reply processing of the response message is invalid in the apparatus setting or the like of the recipient 30B (S3406: NO), a series of the processing operations is ended without replying the response message.

In the above-described third embodiment, after the transmission processing of the image data of S9 is carried out, the processing operations of S10, S3203 and S11 or the processing operations of S10, S3203 and S3204 are carried out. However, before carrying out the transmission processing of the image data of S9, the processing operations of S10, S3203 and S11 or the processing operations of S10, S3203 and S3204 can be carried out. Moreover, while carrying out the transmission processing of the image data of S9, the processing operations of S10, S3203 and S11 or the processing operations of S10, S3203 and S3204 can be carried out.

As described above, according to the facsimile machine 30 of the third embodiment, the transmitter can instruct the recipient facsimile machine to carry out the processing of the image data of the original document transmitted in the media session.

### Fourth Embodiment

Next, referring to the drawings, a description will be made of a facsimile machine according to a fourth embodiment of the present invention. The facsimile machine of the fourth embodiment has the same configuration and the same communication function as the facsimile machine of the third embodiment. Furthermore, the facsimile machine of the fourth embodiment includes an electronic mail communication function and a function for forwarding text data, which is designated arbitrarily by a user of a transmitter facsimile machine, to a prescribed destination. That is, according to the facsimile machine of the fourth embodiment, the transmitter facsimile machine transmits a forwarding instruction command, which indicates to forward the text data, and a forwarding destination instruction command, which indicates a forwarding destination, to a recipient facsimile machine by the SIP method “MESSAGE” along with the text data, which is designated arbitrarily by an operation of the user. Meanwhile, the recipient facsimile machine detects a command from the received text data and executes a processing for forwarding text data described in a prescribed area to a terminal device of destination information designated by the forwarding destination instruction command. Also in the fourth embodiment, the SIP method for transmitting the text data (command) is not limited to “MESSAGE”. If the SIP method can transmit any text data designated by the user, a method of another type can be used.

In the following, with reference to the drawings, a detailed description will be made of a processing operation when a facsimile machine 40 transmits and receives image data according to the fourth embodiment. Further, for the configuration and the processing operation that are the same as the facsimile machine of the first embodiment, the same reference numeral is applied in the drawing and the description will be omitted. For convenience of the description, also in the fourth embodiment, a facsimile machine 40 to be a caller side will be referred to as a transmitter 40A and a facsimile machine 40 to be a called side will be referred to as a recipient 40B.

In the facsimile machine 40, a forwarding instruction command indicating to forward the text data received by the SIP method “MESSAGE” and a forwarding destination instruction command indicating a forwarding destination are set previously. Specifically, “message forwarding” is set as the forwarding instruction command and “transmission destination” is set as the forwarding destination instruction command. When the recipient 40B receives these commands, the recipient 40B forwards a message described in a prescribed area of the received text data to the destination indicated by the forwarding destination instruction command.

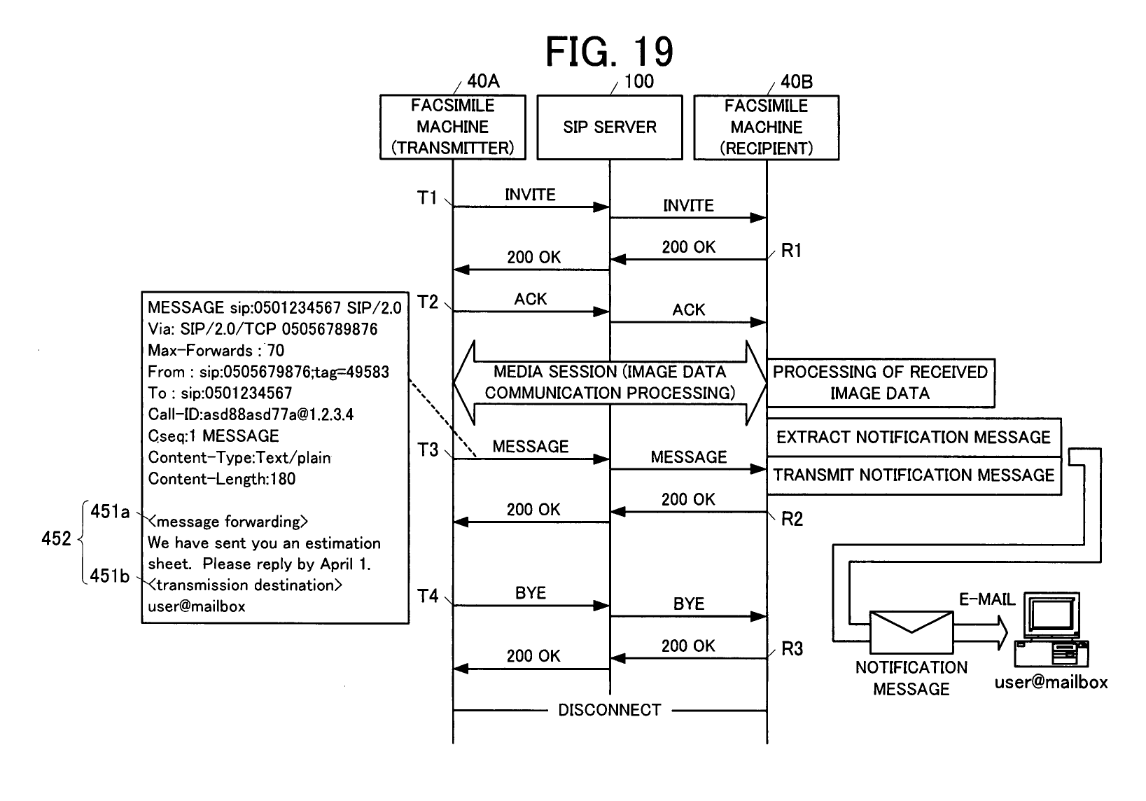

FIG. 19 shows a procedure formed when the transmitter 40A and the recipient 40B transmit and receive the image data and the text data including a command. As shown in the drawing, after the image data of the original document is transmitted from the transmitter 40A to the recipient 40B in the established media session (the procedure shown in FIG. 19 is just one example, and can be before the transmission or during the transmission of the image data of the original document), under a timing independent from the transmission processing of the image data, while the media session is established, the transmitter 40A transmits in the form of electronic mail to the recipient 40B by the SIP method “MESSAGE”, text data in which a forwarding instruction command 451a and a forwarding destination instruction command 451b designated by an operation of the user are described in a prescribed text format, and text data as a message other than the command designated by an operation of the user. As shown in FIG. 19, in text data 452 transmitted from the transmitter 40A to the recipient 40B by the SIP method “MESSAGE”, the commands 451a and 451b are described in a specific format so that the commands 451a and 451b can be distinguished from other text data. That is, the transmitter 40A transmits the text data in which the commands are surrounded by the specific symbols “<” and “>”. The recipient 40B, which received the text data, extracts a part surrounded by the specific symbols. In case the extracted part is “message forwarding”, text data described in a prescribed area of the text data 452 is forwarded to the destination information indicated by the command “transmission destination” indicating the forwarding destination information. Further, in the present embodiment, the text data described in a prescribed area of the received text data, for example, the text data described between the command 451a and the command 451b, is forwarded. However, all of the received text data 452 can be forwarded. In FIG. 19, a communication method used for forwarding the text data is electronic mail. However, the present invention is not limited to this example, and for example, the text data can be forwarded by another communication method such as the G3 facsimile communication.

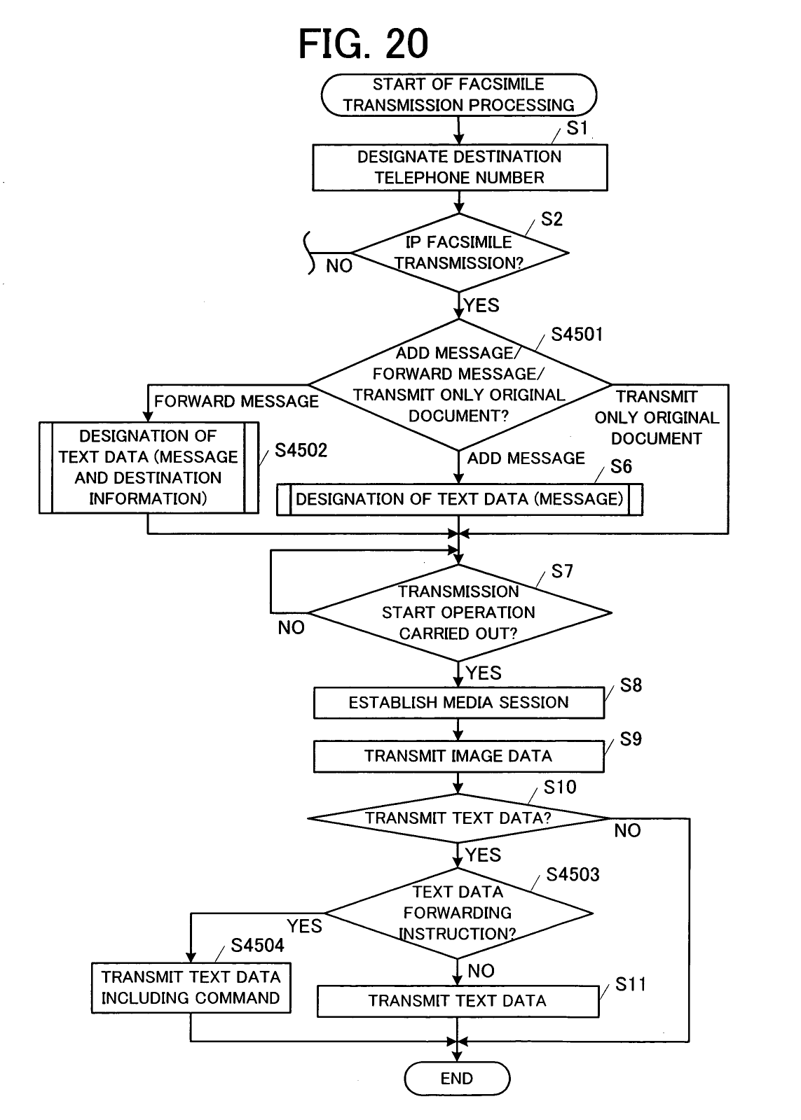

Referring to the flowchart shown in FIG. 20, a detailed description will be made of the processing operation of the above-described transmitter 40A.

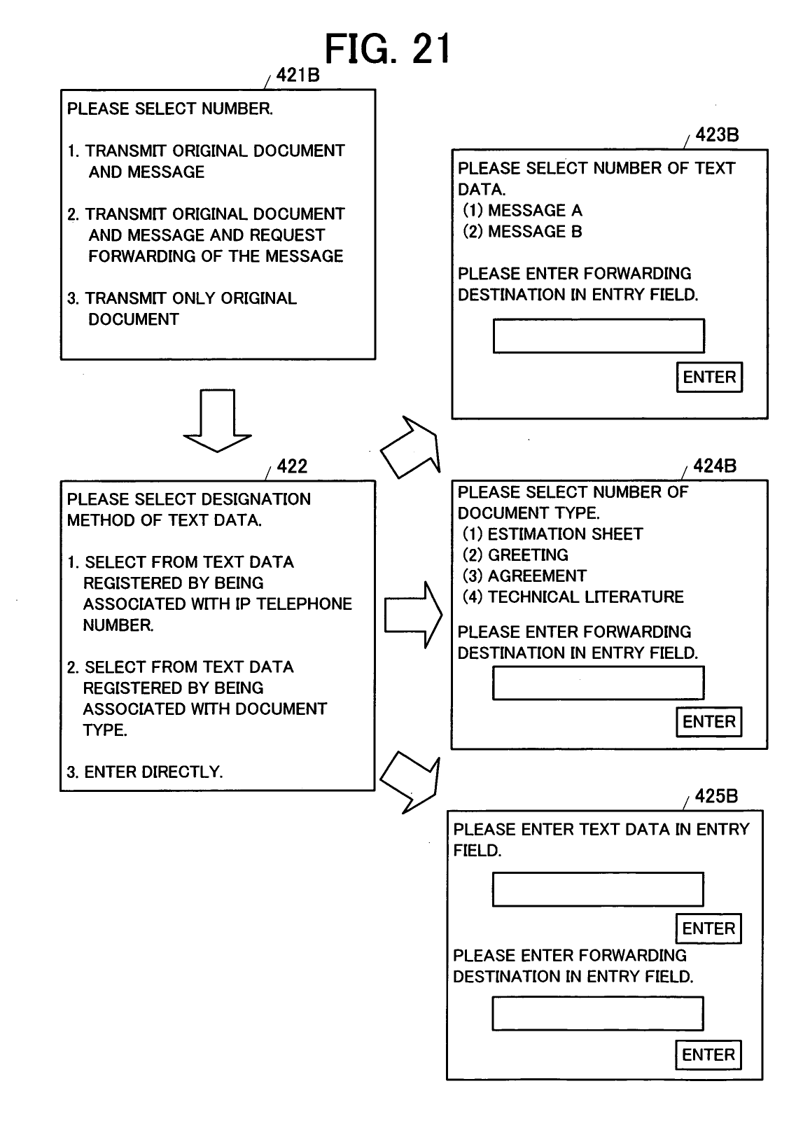

At the transmitter 40A, in case a facsimile transmission operation is carried out by the user and a determination is made at S2 that the designated destination telephone number (destination information) is an IP telephone number (S2: YES), a processing operation is carried out for requesting the user as to an instruction of whether to transmit a message along with the image data of the original document, whether to transmit a message along with the image data of the original document and then to request the message to be forwarded to another terminal device, or whether to transmit only the image data of the original document. For example, the display unit 11 displays a screen 421B as shown in FIG. 21. The screen 421B displays selectable items such as “Transmit original document and message”, “Transmit original document and message and request forwarding of the message” and “Transmit only original document”. When either one of the items is selected by a prescribed operation, a corresponding screen is displayed on the display unit 11, respectively.

In case “Transmit original document and message” is selected, the transmitter 40A determines to transmit the message along with the image data of the original document (S4501: add message). Then, the process proceeds onto S6 and the processing operations S101 through S108 described in the first embodiment are executed.

In case “Transmit original document and message and request forwarding of the message” is selected, the transmitter 40A determines to transmit text data along with the image data of the original document and then to request a forwarding of the text data (S4501: forward message). Then, the text data and the forwarding destination information of the text data are designated by a prescribed operation of the user (S4502).

The designation of the text data or the like at S4502 is carried out by selecting from the text data registered in the first table 4b by being associated with the IP telephone number designated at S1, selecting from the text data registered in the second table 4c by being associated with the type of the original document, or by entering a character or the like directly by the user. Specifically, after the determination of S4501, the transmitter 40A displays on the display unit 11, a screen 422 as shown in FIG. 21 for selecting the designation method of the text data (S101). The screen 422 displays selectable items such as “Select from text data registered by being associated with IP telephone number”, “Select from text data registered by being associated with document type” and “Enter directly”. When either one of the items is selected by a prescribed operation, a corresponding screen 423B, 4244B or 425B is displayed on the display unit 11.

In case the item displayed as “Select from text data registered by being associated with IP telephone number” is selected (S102: for destination), the display unit 11 displays the text data selection screen 423B which displays the text data stored in the first table 4b by being associated with the IP telephone number designated at S1 in a manner that text data can be selected (S4601). The selection screen 423B also displays an entry field for entering forwarding destination information. In case either one of the text data displayed on the selection screen 423B is selected by a prescribed operation and the destination information is entered in the entry field, the selection result and the entered destination information are stored in the RAM 4 until the text data is transmitted later (S4602).

In case the item displayed as “Select from text data registered by being associated with document type” is selected (S102: for document type), the display unit 11 displays the document type selection screen 424B which displays the document types registered in the second table 4c in a manner that a document type can be selected (S4603). The selection screen 424B also displays an entry field for entering forwarding destination information. In case either one of the document types displayed on the selection screen 424B is selected by a prescribed operation and the destination information is entered in the entry field, the selection result and the entered destination information are stored in the RAM 4 until the text data is transmitted later (S4604).

In case the item displayed as “Enter directly” is selected (S102: enter directly), for example, the display unit 11 displays the entry screen 425B as shown in FIG. 21 for entering text data and forwarding destination (S4605). In case the text data is entered directly by a key operation or the like of the operation unit 12, the entered text data (the message and the forwarding destination information) is stored until the text data is transmitted later (S4606).

Meanwhile, in case “Transmit only original document” is selected at S4501 and the transmitter 40A determines to transmit only the image data of the original document (S4501: transmit only original document), or in case the processing operation of S6 is executed, or in case the processing operation of S4502 is executed, the transmitter 40A executes the processing operations of S7 through S9 subsequently.

In case a determination is made at S4501 to transmit the message along with the image data of the original document, a determination is made not to carry out the forwarding instruction of the text data to be transmitted (S4503: NO) and the process proceeds onto S11. In accordance with the selection result or the entered text data stored at S104, S106 or S108, the designated text data to be transmitted is retrieved and the retrieved text data is transmitted to the recipient 40B by the SIP method “MESSAGE” (S11).

Meanwhile, in case a determination is made at S4501 to transmit the text data along with the image data of the original document and then to request the forwarding of the text data, a determination is made to carry out the forwarding instruction of the text data to be transmitted (S4503: YES). In accordance with the selection result or the entered information stored at S4602, S4604 or S4606, the designated text data to be transmitted and the destination information for forwarding the text data are retrieved. Then, the retrieved text data is transmitted to the recipient 40B by the SIP method “MESSAGE” (S4504). For example, as shown in FIG. 19, the transmitter 40A transmits to the recipient 40B by the SIP method “MESSAGE”, the text data in which “<message forwarding>”, which “<” and”>” are attached to the forwarding instruction command, the text data (the message) to be transmitted, “<transmission destination>”, which “<” and “>” are attached to the forwarding destination instruction command, and the destination information are described in this order (S4504).

In case a determination is made at S4501 to transmit only the image data of the original document, a determination is made at S10 not to transmit the text data (S10: NO). Then, “BYE” is transmitted without carrying out the transmission processing of the text data and the communication with the recipient 40B is disconnected (T4)

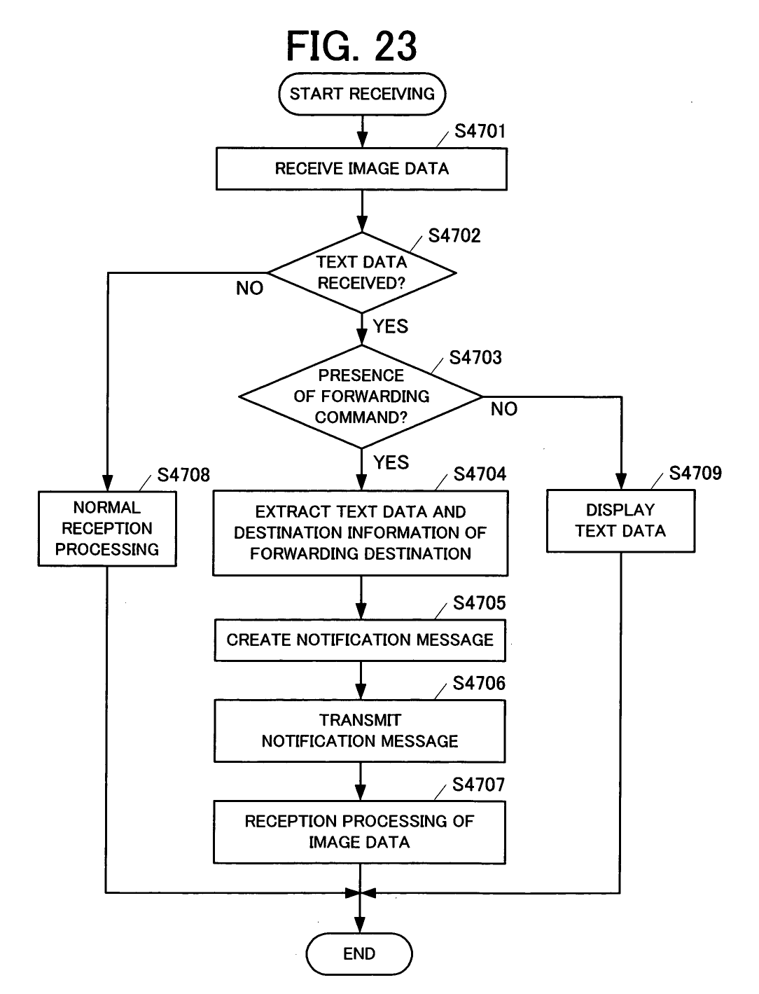

Next, referring to the flowchart shown in FIG. 23, a detailed description will be made of the processing operation of the recipient 40B, which receives the image data of the original document. The recipient 40B receives the image data of the original document from the transmitter 40A in the media session (S4701). When the recipient 40B receives the text data 452 by the SIP method “MESSAGE” (S4702: YES), the recipient 40B determines whether or not a forwarding instruction command is included in the received text data (S4703). That is, in case a forwarding instruction command “<message forwarding>” 451a is included in the received text data, the recipient 40B determines that the received text data is the text data to be forwarded (S4703: YES). The recipient 40B extracts information described between “<message forwarding>” and “<transmission destination>” as the text data to be forwarded and extracts information described after the forwarding destination instruction command “<transmission destination>” 451b as destination information of a forwarding destination of the text data (S4704)

The recipient 40B creates a file (for example, an electronic mail file) in which the extracted forwarding text data is described as a notification message (S4705). The recipient 40B transmits the notification message to the destination information (for example, an electronic mail address) instructed by the forwarding destination instruction command (S4706). Then, the recipient 40B executes a reception processing, for example, a print processing by the printer unit 10, on the image data of the original document received in the media session (S4707). Further, in case the destination information is not described, the notification message can be forwarded to a prescribed destination (for example, an electronic mail address, a facsimile number) set previously in the facsimile machine 40.

Meanwhile, in case a negative determination is made at S4702, the recipient 40B executes a normal reception processing, for example, a print processing or a distribution processing to a prescribed client PC (S4708). In case a negative determination is made at S4703, the recipient 40B carries out an output processing of the received text data (for example, displays the received text data on the display unit 11) (S4709).

Further, in the fourth embodiment, after the transmission processing of the image data of S9, the transmitter 40A carries out the transmission processing of the text data (command, message, etc.) of S11 and S4505. However, prior to the transmission processing of the image data of S9, the transmitter 40A can carry out the processing operations of S10, S4503 and S11 or the processing operations of S10, S4503 and S4504. Alternatively, while carrying out the transmission processing of the image data of S9, the transmitter 40A can carry out the processing operations of S10, S4503 and S11 or the processing operations of S10, S4503 and S4504.

As described above, according to the facsimile machine 40 of the fourth embodiment, the text data can be transmitted and received while transmitting and receiving the image data of the original document in the media session established by the SIP. Furthermore, the text data received by the recipient 40B can be forwarded automatically to another terminal device. Accordingly, for example, in case a user using the recipient 40B is located away from the recipient 40B, a reception of an original document or the like can be notified to a terminal device located close to the user and the user at the receiving side can take a prompt action for the received original document.

### Fifth Embodiment

Next, with reference to the drawings, a description will be made of a facsimile machine according to a fifth embodiment of the present invention. The facsimile machine of the fifth embodiment includes substantially the same configuration and the same communication function as the facsimile machine of the first embodiment. Furthermore, the facsimile machine of the fifth embodiment includes a function for reading out by voice, a content of text data received by the SIP method “MESSAGE”. Also in the fifth embodiment, the SIP method for transmitting the text data is not limited to “MESSAGE”. If the SIP method can transmit any text data designated by the user, a method of another type can be used.

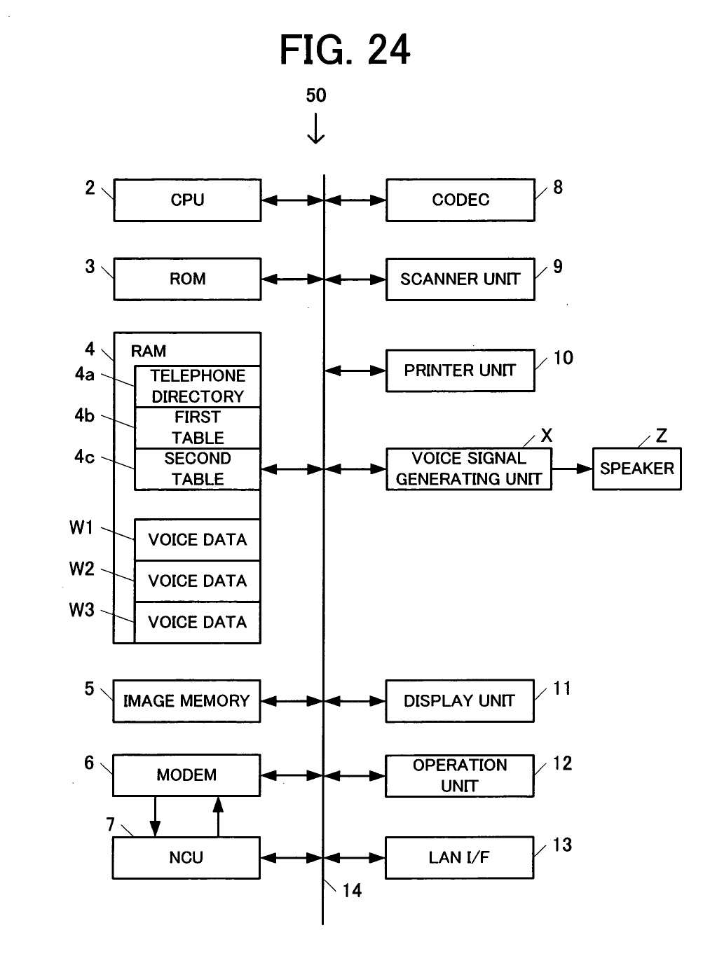

FIG. 24 shows an example of a configuration of a facsimile machine 50 according to the fifth embodiment. In the configuration of the facsimile machine 1 of the first embodiment shown in FIG. 1, the facsimile machine 50 of the fifth embodiment further includes a voice signal generating unit X and a speaker Z, which generates voice by a voice signal output from the voice signal generating unit X.

The voice signal generating unit X converts received text data into voice data, executes a data processing such as a Digital-to-Analog (D/A) conversion and outputs voice to the speaker Z. Specifically, the voice signal generating unit X retains voice signals associated with various text data. The voice signal generating unit X receives character information of the received text data from the CPU 2, and sequentially retrieves the voice signals associated with various text data from the retaining data. Then, the voice signal generating unit X executes the data processing such as the D/A conversion and outputs voice to the speaker Z. Accordingly, the content of the text data received by the SIP method “MESSAGE” is output by voice from the speaker Z (in other words, the content of the received text data is read out). Further, the text data output by voice is primarily character data associated with a character which can be pronounced by a person such as “a, i, u, e, o” and “ABC”. In case the voice signal generating unit X receives the voice data from the CPU 2, the voice signal generating unit X executes the data processing such as the D/A conversion on the received voice data and outputs the processed voice data to the speaker Z.

As shown in FIG. 24, in a prescribed area of the RAM 4, three types of voice data W1 through W3 are registered (stored). The voice data W1 has a voice content which notifies a reception of facsimile, for example, “Fax has been received”. The voice data W2 has a voice content which notifies a reception of text data, for example, “Message has been received”. The voice data W3 has a voice content which notifies a reception of both facsimile and text data, for example, “Fax and message have been received”. In accordance with a type of the data received from the transmitter facsimile machine, the CPU 2 selects either one of the plurality of the voice data W1 through W3 and transmits the selected voice data to the voice signal generating unit X. Then, the voice signal generating unit X executes the D/A conversion processing or the like on the voice data W1 or the like and the content of the voice data W1 or the like is output by voice from the speaker Z. Further, as a type of the data to be received, there are a case in which only the image data is received, a case in which only the text data is received and a case in which both the image data and the text data are received.

In the following, with reference to the drawings, a detailed description will be made of a processing operation executed by the facsimile machine 50 when receiving image data according to the fifth embodiment. For the configuration and the processing operation that are the same as the facsimile machine of the first embodiment, the same reference numeral will be applied in the drawing and the description will be omitted. For example, since the processing operation executed by the facsimile machine 50 when transmitting the image data and the text data is the same as the processing operation in the first embodiment, the description will be omitted. For convenience of the description, also in the fifth embodiment, the facsimile machine 50 to be a caller side will be referred to as a transmitter 50A and the facsimile machine 50 to be a called side will be referred to as a recipient 50B.

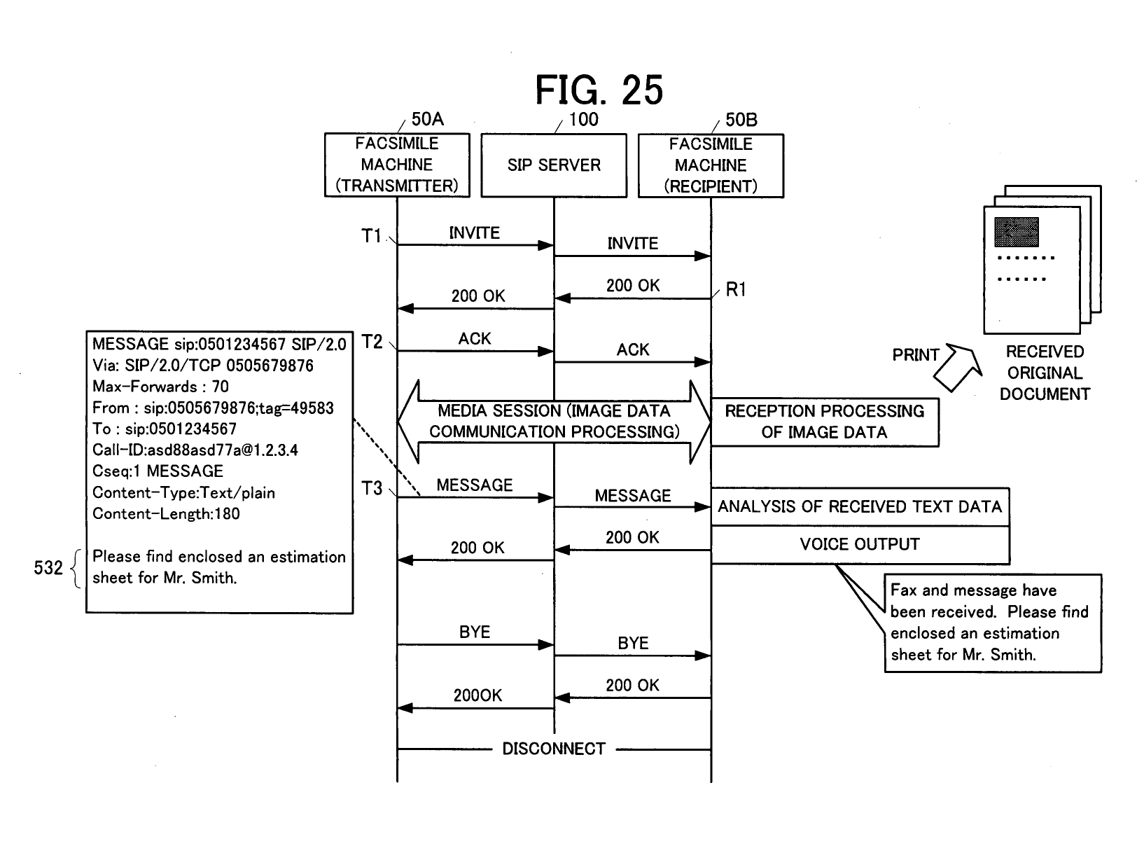

FIG. 25 shows a procedure formed when the facsimile machines 50 transmit and receive the image data of the original document and the text data according to the fifth embodiment. That is, after establishing a media session, the transmitter 50A and the recipient 50B transmit and receive the image data. In addition, at T3, the transmitter 50A transmits text data 532 as shown in the drawing to the recipient 50B by the SIP method “MESSAGE” under a timing independent from the transmission processing of the image data. That is, the text data is transmitted to the recipient 50B by the SIP method “MESSAGE” at the same time as the transmission processing of the image data or before or after the transmission processing of the image data. Further, for each time when the transmission processing of the image data of the original document is carried out, the transmission processing of the text data by the SIP method “MESSAGE” can be carried out for a plural number of times.

When the recipient 50B receives the image data of the original document and the text data 532 from the transmitter 50A, the recipient 50B prints out the image data by the printer unit 10 and executes a processing operation on the text data 532 to read out the content of the text data 532.

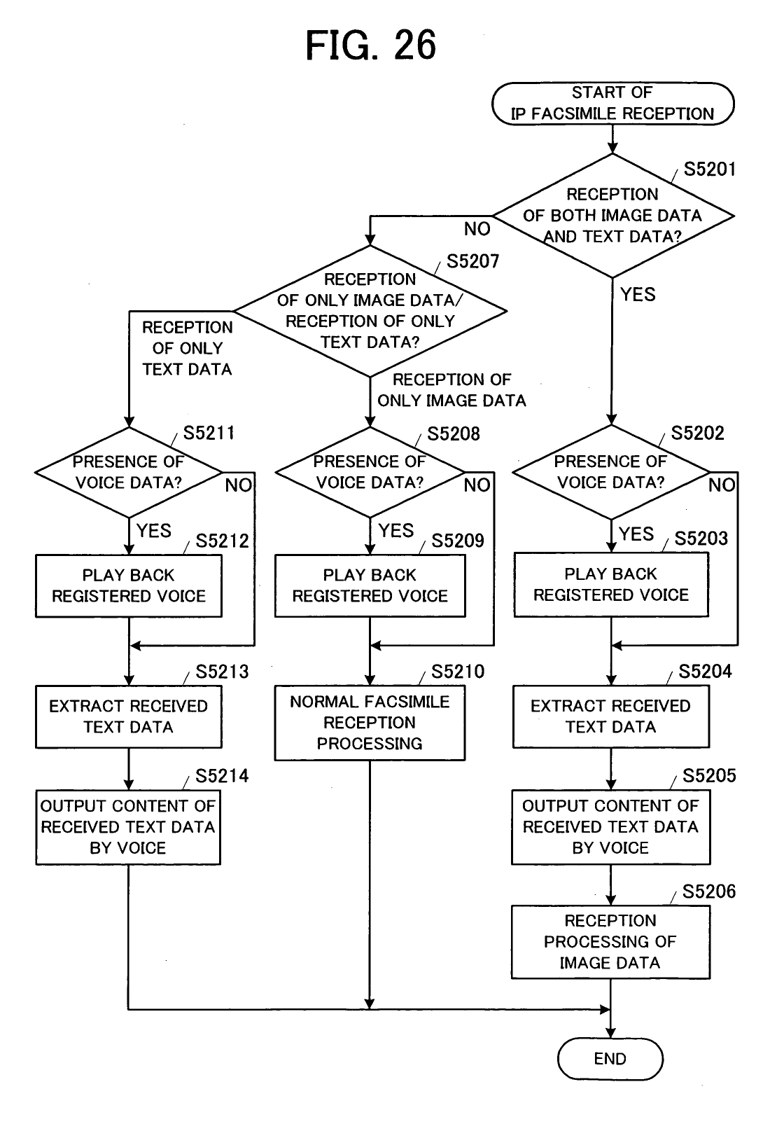

With reference to the flowchart shown in FIG. 26, a detailed description will be made of the processing operation executed by such a recipient 50B. In case the recipient 50B receives the image data in the media session and also receives the text data by the SIP method “MESSAGE” (S5201: YES), a determination is made as to whether or not the voice data W3 is registered (stored) in the RAM 4. In case a determination is made that the voice data W3 is registered in the RAM 4 (S5202: YES), the voice data W3 is retrieved and the D/A conversion processing or the like is executed by the voice signal generating unit X. Then, an announce voice, for example, “Fax and message have been received”, is played (output) from the speaker Z (S5203).

Next, the text data 532 received by the SIP method “MESSAGE” is extracted (S5204). The character information of the text data 532 is transmitted to the voice signal generating unit X. The voice signal generating unit X sequentially retrieves a voice signal associated with the character information and executes the data processing such as the D/A conversion. Then, the voice signal generating unit X outputs voice to the speaker Z. Accordingly, the content of the text data received by the SIP method “MESSAGE”, for example, “Please find enclosed an estimation sheet for Mr. Smith”, is output by voice from the speaker Z (S5205). At last, the processing for the received image data, such as a distribution processing or a print processing of the image data based on an apparatus setting, is carried out (S5206).

Meanwhile, in case the recipient 50B receives the image data in the media session but does not receive the text data (S5201: NO, S5207: reception of only image data), a determination is made as to whether or not the voice data W2 is registered in the RAM 4. In case the voice data W2 is registered in the RAM 4 (S5208: YES), the voice data W2 is retrieved and the D/A conversion processing or the like is executed by the voice signal generating unit X. Then, an announce voice, for example, “Fax has been received”, is played (output) from the speaker Z (S5209). Subsequently, a normal facsimile reception processing, such as the distribution processing and the print processing of the image data based on the apparatus setting, is carried out (S5210).

Meanwhile, in case the recipient 50B receives the text data by the SIP method “MESSAGE” but does not receive the image data (S5207: reception of only text data), a determination is made as to whether or not the voice data W3 is registered in the RAM 4. In case the voice data W3 is registered in the RAM 4 (S5211: YES), the voice data W3 is retrieved and the D/A conversion processing or the like is executed by the voice signal generating unit X. Then, and an announce voice, for example, “Message has been received”, is played (output) from the speaker Z (S5212). Next, the text data received by the SIP method “MESSAGE” is extracted (S5213) and character information of the extracted text data is transmitted to the voice signal generating unit X. Then, the voice signal generating unit X sequentially retrieves a voice signal associated with the text data and executes the data processing such as the D/A conversion. Subsequently, the voice signal generating unit X outputs voice to the speaker Z. Accordingly, the content of the text data received by the SIP method “MESSAGE”, for example, “Please circulate the estimation sheet transmitted earlier to Mr. Smith”, is output by voice from the speaker Z (S5214).

As described above, according to the facsimile machine 50 of the fifth embodiment, the image data of the original document is transmitted and a comment designated arbitrarily by the user is read out by voice at the recipient. Therefore, the user of the recipient can confirm the comment of the transmitter by voice without going to a handset of the facsimile machine.

1. An image communication device, comprising:
means for transmitting image data in a media session established by a call control protocol;
a text data designating means for designating text data to be transmitted; and
a text data transmitting means for transmitting the designated text data by a method of the call control protocol.

2. The image communication device according to claim 1, wherein a transmission of the text data carried out by the text data transmitting means is carried out while the media session is established.

3. The image communication device according to claim 1, further comprising:
means for storing a plurality of text data;
wherein the text data designating means designates the text data selected from the plurality of the text data stored in the means for storing as the text data to be transmitted.

4. The image communication device according to claim 2, further comprising:
means for storing a plurality of text data;
wherein the text data designating means designates the text data selected from the plurality of the text data stored in the means for storing as the text data to be transmitted.

5. The image communication device according to claim 1, further comprising:
means for storing destination information and text data by associating each with one another;
wherein the text data designating means designates the text data stored in the means for storing by being associated with the destination information of a communication destination as the text data to be transmitted.

6. The image communication device according to claim 2, further comprising:
means for storing destination information and text data by associating each with one another;
wherein the text data designating means designates the text data stored in the means for storing by being associated with the destination information of a communication destination as the text data to be transmitted.

7. The image communication device according to claim 1, further comprising:
means for storing a type of image data to be transmitted and text data by associating each with one another; and
a type designating means for designating the type of the image data to be transmitted;
wherein the text data designating means designates the text data stored in the means for storing by being associated with the type designated by the type designating means as the text data to be transmitted.

8. The image communication device according to claim 2, further comprising:
means for storing a type of image data to be transmitted and text data by associating each with one another; and
a type designating means for designating the type of the image data to be transmitted;
wherein the text data designating means designates the text data stored in the means for storing by being associated with the type designated by the type designating means as the text data to be transmitted.

9. An image communication device, comprising:
means for transmitting and receiving image data in a media session established by a call control protocol; and
means for outputting text data received by a method of the call control protocol.

10. The image communication device according to claim 9, wherein the output is a display output.

11. An image communication device, comprising:
means for transmitting and receiving image data in a media session established by a call control protocol;
a text data designating means for designating text data to be replied to a transmitter of the text data received by a method of the call control protocol; and
means for replying the designated text data to the transmitter.

12. An image communication device, comprising:
an image data transmitting means for transmitting image data in a media session established by a call control protocol;
a command designating means for designating a text format command indicating a processing to be executed on the image data to be transmitted; and
a command transmitting means for transmitting the designated command by a method of the call control protocol.

13. The image communication device according to claim 12, wherein a transmission of the command carried out by the command transmitting means is carried out while the media session is established.

14. An image communication device, comprising:
an image data receiving means for receiving image data in a media session established by a call control protocol;
a text data receiving means for receiving text data by a method of the call control protocol;
means for storing a text format command and a processing to be executed by associating each with one another; and
means for executing the processing associated with the command on the image data received by the image data receiving means when the text data received by the text data receiving means corresponds with the command stored in the means for storing.

15. An image communication device, comprising:
an image data receiving means for receiving image data in a media session established by a call control protocol;
a text data receiving means for receiving text data by a method of the call control protocol; and
means for forwarding, wherein when a forwarding instruction command is included in the text data received by the text data receiving means, the means for forwarding forwards text data described in a prescribed area of the text data to a prescribed destination.

16. The image communication device according to claim 15, wherein when a forwarding destination instruction command indicating the prescribed destination is also included in the text data received by the text data receiving means, the means for forwarding forwards the text data described in the prescribed area to a forwarding destination indicated by the forwarding destination instruction command.

17. An image communication device, comprising:
an image data receiving means for receiving image data in a media session established by a call control protocol;
a text data receiving means for receiving text data by a method of the call control protocol; and
means for converting the text data received by the text data receiving means into voice data and outputting the voice data.

18. An image communication device, comprising:
an image data receiving means for receiving image data in a media session established by a call control protocol;
a text data receiving means for receiving text data by a method of the call control protocol;
means for storing a plurality of voice data; and
means for selecting one voice data from the plurality of the voice data stored in the means for storing in accordance with a type of the image data and the text data received by the image data receiving means and the text data receiving means and outputting the selected voice data.
